(19) United States
(12) Patent Application Publication
(10) Pub. No.: US 2026/0366923 A1
(43) Pub. Date: Nov. 19, 2026

(54) BOLOMETER-TYPE INFRARED DETECTOR

(71) Applicant: NEC Corporation, Tokyo (JP)

(72) Inventors: Tomo TANAKA, Tokyo (JP); Masahiko SANO, Tokyo (JP); Ryota YUGE, Tokyo (JP)

(73) Assignee: NEC Corporation, Tokyo (JP)

(21) Appl. No.: 19/672,981

(22) Filed: May 11, 2026

(30) Foreign Application Priority Data
May 16, 2025 (JP) 2025-082428

(51) Int. Cl. G01J 5/22; G01J 5/20

(52) U.S. Cl. CPC G01J 5/22; G01J 2005/202

(57) ABSTRACT

A bolometer-type infrared detector includes a plurality of absorption layers stacked spaced apart from each other, two or more thereof having different absorption wavelength spectra, wherein the plurality of absorption layers are configured to acquire a plurality of images in different wavelength bands with a same field of view.

### FIELD

### Cross Reference to Related Applications

This application is based upon and claims the benefit of the priority of Japanese patent application No. 2025-082428, filed on May 16, 2025, the disclosure of which is incorporated herein in its entirety by reference thereto.

This disclosure relates to a bolometer-type infrared detector.

### BACKGROUND

FIG. 24A is a perspective diagram schematically illustrating one example of a cell structure of a bolometer, which is one type of an uncooled infrared detector. FIG. 24B a diagram schematically . . . is illustrating a cross-section along line A-A′ in FIG. 24A (reference may be made to Patent Literature 1). Referring to FIGS. 24A and 24B, the bolometer includes a diaphragm-type insulation section 304 that is arranged over a silicon substrate 301 and isolated from the silicon substrate 301 through a cavity 307 supported by a leg section 342. The insulation section 304 positioned spaced apart from one surface of the silicon substrate 301 includes a support section 341 with an infrared detection section 303 formed on a side thereof opposite the silicon substrate 301, and a leg section 342 connecting the support section 341 to the silicon substrate 301. An infrared detection section 303 is provided on the insulation section 304. When infrared radiation is entered, the infrared detection section 303 is heated. A change of a resistance of the infrared detection section 303 due to temperature change is detected. For example, vanadium oxide may be used as a bolometer film of the infrared detection section 303. Silicon nitride (SiN) may be used as a base material for the diaphragm-type insulation section 304. SiN may be used as a coating material to coat the bolometer film. For a bolometer, a thickness of silicon nitride (SiN) and that of vanadium oxide, both optimized for detection capability, may not sufficiently absorb infrared light. An infrared reflective film 306 is provided to reflect light that has passed through the bolometer film. The infrared reflective film 306 causes the light reflected therefrom to re-enter the bolometer film. Silicon micro electro-mechanical system (MEMS) processes are typically used to fabricate the above-described structure. In MEMS processes requiring precision, difficulty in manufacturing the diaphragm-type insulation section 304 and difficulty in forming the resistive element material affect factors such as a yield rate, thereby also raising manufacturing costs.
[Patent Literature 1] JP2007-263769 A

### SUMMARY

Combined imaging, which combines a plurality of images from different wavelength bands, increases amount of information. Accordingly, a bolometer-type infrared detector enabled to acquire image within a same field of view is desirable. In this context, simplification of MEMS fabrication process is also desirable.

The present disclosure provides a bolometer-type infrared detector that solves the above issues.

According to at least one of embodiments of the present disclosure, a bolometer-type infrared detector includes a plurality of absorption layers stacked spaced apart from each other, two or more thereof having absorption wavelength spectra different to each other, wherein the plurality of absorption layers are configured to acquire a plurality of images in different wavelength bands with a same field of view.

According to at least one embodiment of the present disclosure, a bolometer-type infrared detector includes: a substrate; a first wiring layer with a first side thereof facing the substrate covered with a protective film, and a second side opposite to the first side and an outer edge thereof both covered with a protective film; a second wiring layer with a first side thereof facing the first wiring layer covered with a protective film, wherein on a second side opposite to the first side of the second wiring layer, a laminated structure including at least a first semiconductor-type carbon nanotube film, a protective film covering the semiconductor-type first carbon nanotube film, and a first absorption layer with a first absorption wavelength spectrum is arranged; and a third wiring layer with a first side thereof facing the second wiring layer covered with a protective film, wherein on a second side opposite to the first side of the third wiring layer, a laminated structure including at least a semiconductor-type second carbon nanotube film, a protective film covering the semiconductor-type second carbon nanotube film, and a second absorption layer with a second absorption wavelength is arranged.

The first wiring layer includes a first connection part with one end in contact with a contact electrode arranged on the substrate, the second wiring layer includes a second connection part with one end in contact with a first contact area of the first wiring layer, and the third wiring layer includes a third connection part with one end in contact with a second contact area of the second wiring layer. The first connection part serves as a support member to support the first wiring layer at a predetermined distance from the substrate, the second connection part serves as a support member to support the second wiring layer at a predetermined distance from the first wiring layer, and the third connection part serves as a support member to support the third wiring layer at a predetermined distance from the second wiring layer.

According to this disclosure, in combining a plurality of images from different wavelength bands, it is made possible to acquire a plurality of images with a same field of view is enabled. In addition to the above, it is made possible to simplify MEMS fabrication process.

### BRIEF DESCRIPTION OF THE DRAWINGS

FIG. 1 is a diagram illustrating at least one basic configuration of several embodiments of the present disclosure.

FIGS. 2A through 2C illustrate an example of several embodiments of the present disclosure.

FIGS. 3A through 3C illustrate an example of several embodiments of the present disclosure.

FIG. 4 illustrates an example of several embodiments of the present disclosure.

FIG. 5 illustrates an example of several embodiments of the present disclosure.

FIG. 6 illustrates an example of several embodiments of the present disclosure.

FIG. 7 illustrates an example of several embodiments of the present disclosure.

FIG. 8 is a schematic decomposition diagram illustrating an example configuration of several embodiments of the present disclosure.

FIGS. 9A through 9E illustrate diagrams describing at least one pattern of several embodiments of the present disclosure.

FIG. 10A is a schematic cross-sectional diagram illustrating at least one configuration of several embodiments of the present disclosure.

FIG. 10B is a SEM image of a surface of a connection part.

FIG. 11 illustrates schematic cross-sectional diagrams (P1) through (P4) of at least one fabrication process of several embodiments of the present disclosure.

FIG. 12 illustrates schematic cross-sectional diagrams (P5) through (P8) of at least one fabrication process of several embodiments of the present disclosure.

FIG. 13 illustrates schematic cross-sectional diagrams (P9) through (P12) of at least one fabrication process of several embodiments of the present disclosure.

FIG. 14 illustrates schematic cross-sectional diagrams (P13) through (P16) of at least one fabrication process of several embodiments of the present disclosure.

FIG. 15 illustrates schematic cross-sectional diagrams (P17) through (P20) of at least one fabrication process of several embodiments of the present disclosure.

FIG. 16 illustrates schematic cross-sectional diagrams (P21) through (P24) of at least one fabrication process of several embodiments of the present disclosure.

FIG. 17 illustrates schematic cross-sectional diagrams (P25) through (P28) of at least one fabrication process of several embodiments of the present disclosure.

FIG. 18 illustrates schematic cross-sectional diagrams (P29) through (P32) of at least one fabrication process of several embodiments of the present disclosure.

FIG. 19A is a plan diagram illustrating at least one wiring pattern of some embodiments of the present disclosure.

FIG. 19B is a schematic cross-sectional diagram illustrating at least one wiring pattern of some embodiments of the present disclosure.

FIG. 20A is a plan diagram illustrating at least one wiring pattern of some embodiments of the present disclosure.

FIG. 20B is a schematic cross-sectional diagram illustrating at least one wiring pattern of some embodiments of the present disclosure.

FIG. 21A is a plan diagram illustrating at least one wiring pattern of some embodiments of the present disclosure.

FIG. 21B is a schematic cross-sectional diagram illustrating at least one wiring pattern of some embodiments of the present disclosure.

FIGS. 22A and 22B are schematic diagrams illustrating at least one wiring pattern of some embodiments of the present disclosure.

FIG. 23 illustrates a bolometer-type infrared imaging apparatus equipped with a two-dimensional cell array.

FIGS. 24A and 24B illustrate the disclosure of Patent Literature 1.

FIG. 25 illustrates the disclosure of Reference Literature 1.

### EXAMPLE EMBODIMENTS

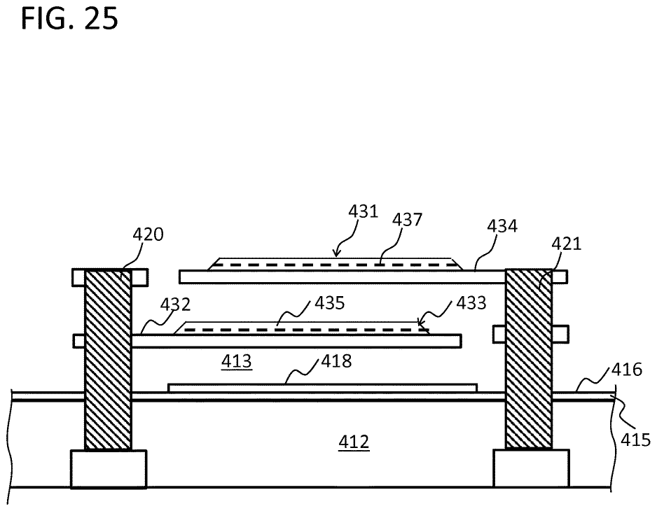

The embodiments of the present disclosure are described. First, a dual-band detector equipped with detectors for first and second operational wavelength bands disclosed in Reference Literature 1 (JP2000-500577A) is described with reference to FIG. 25. In FIG. 25, 412 is a semiconductor substrate, 415 is a readout integrated circuit (ROIC), 416 is a protective layer 431 and 433 are operating regions, 435 and 437 are Temperature Coefficient of Resistance (TCR) materials, 432 is a first microbridge level (detector for the first operational wavelength band), and 434 is a second microbridge level (detector for the second operational wavelength band). The second microbridge level (detector for the second operating wavelength band) 434 preferably has a sensing element that absorbs target incident electromagnetic radiation in the longwave (LW) band and transmits electromagnetic radiation outside a corresponding target wavelength band. The first microbridge level (detector for the first operating wavelength band) 432 preferably has a sensing element that absorbs target incident electromagnetic radiation in the medium wave (MW) band. A cavity 413 is provided between the second microbridge level 434 and a reflector 418. Support pillars 420 and 421, which respectively support the first microbridge level 432 and the second microbridge level 434, are positioned at locations spaced apart from the operating regions 431 and 433, making cell miniaturization difficult. Furthermore, in Reference Literature 1, as an example of a readout circuit, a detector line common to both the detector for the first operating wavelength band and the detector for the second operating wavelength band is provided so that the detector for the first operating wavelength band and the detector for the second operating wavelength band is switched to sequentially turn on the detectors for reading out the signals.

Reference Literature 2 (Manijeh Razeghi, Arash Dehzangi, Jiakai Li, “Multi-band SWIR-MWIR-LWIR Type-II superlattice based infrared photodetector”, January 2021 Results in Optics 2(1): 100054) discloses a quantum-type infrared detector with sensitivity to different wavelengths. Cooled systems offer high sensitivity and excellent responsiveness, while require a cooler, leading to larger, more expensive equipment with high power consumption and necessitating regular cooler maintenance. Furthermore, there is no description or indication for enabling image acquisition at perfectly identical timing for composite imaging combining a plurality of images from different wavelength bands.

The above issue is one example. The present disclosure, in various scenarios not limited to the above issue, enables acquisition of a plurality of images with a same field of view in composite imaging that combines a plurality of images from different wavelength bands. The present disclosure makes it possible to simplify fabrication process. The present disclosure enables to implement cell miniaturization and/or implement a large-scale two-dimensional cell array while saving costs.

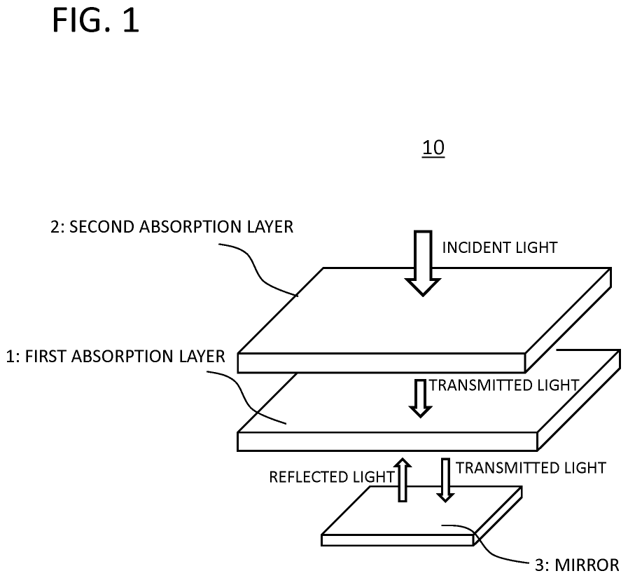

FIG. 1 is a diagram illustrating a basic principle of a bolometer-type infrared detector cell of one of embodiments of the present disclosure. Referring to FIG. 1, a cell 10 includes a first absorption layer 1 and a second absorption layer 2, which possess different infrared transmission/absorption characteristics for an infrared incident direction. The first absorption layer 1 and the second absorption layer 2 are laminated with light-receiving surfaces thereof parallel and spaced apart from each other. A mirror 3, arranged beneath the first absorption layer 1 and opposed thereto, reflects a transmitted light that has transmitted through the first absorption layer 1, and the reflected light re-enters the first absorption layer 1.

The first absorption layer 1 and the second absorption layer 2 may be selected from, for example, the following three sets of absorber groups.
(1) First absorber group (MWIR selective absorption material) selectively absorbs radiation in MWIR (Mid-wavelength infrared: wavelength 3-5 μm (micrometers)) band (high absorbance in the MWIR band) and selectively transmits radiation in LWIR (Long-wavelength infrared: wavelength 7-12 μm) band (high transmittance in the LWIR band).
(2) Second absorber group (LWIR selective absorption material) selectively absorbs radiation the LWIR band (high absorbance in the LWIR band), and selectively transmits radiation in the MWIR band (high transmittance in MWIR band).
(3) Third absorber group absorbs radiation in both MWIR and LWIR bands (high absorbance in both MWIR and LWIR bands) and does not transmit radiation in either MWIR band or LWIR band (low transmittance).

The first to third absorber groups described above include, for example, the following.

The first absorber group (MWIR selective absorption material), for example, may include a carbon nanotube (CNT) film with controlled diameter or chirality to exhibit selective absorption in MWIR band (Reference Literature 3: Kuan-Chang Chiu et al., “Strong and Broadly Tunable Plasmon Resonances in Thick Films of Aligned Carbon Nanotubes”, August 2017, Nano Letters 17(9)).

The second absorber group (LWIR selective absorption material) may include CNT film with controlled diameter or chirality to exhibit selective absorption in LWIR band. The second absorber group may include sintered bodies exhibiting selective absorption at wavelengths in LWIR band. For example, the second absorber group may include oxide ceramic materials. As the LWIR selective absorption materials, sintered bodies of aluminum oxide (alumina) Al₂O₃, yttrium oxide (yttria) Y₂O₃, or rare earth-containing oxide ceramics, such as yttrium aluminum garnet Y₃Al₅O₁₂ may be included.

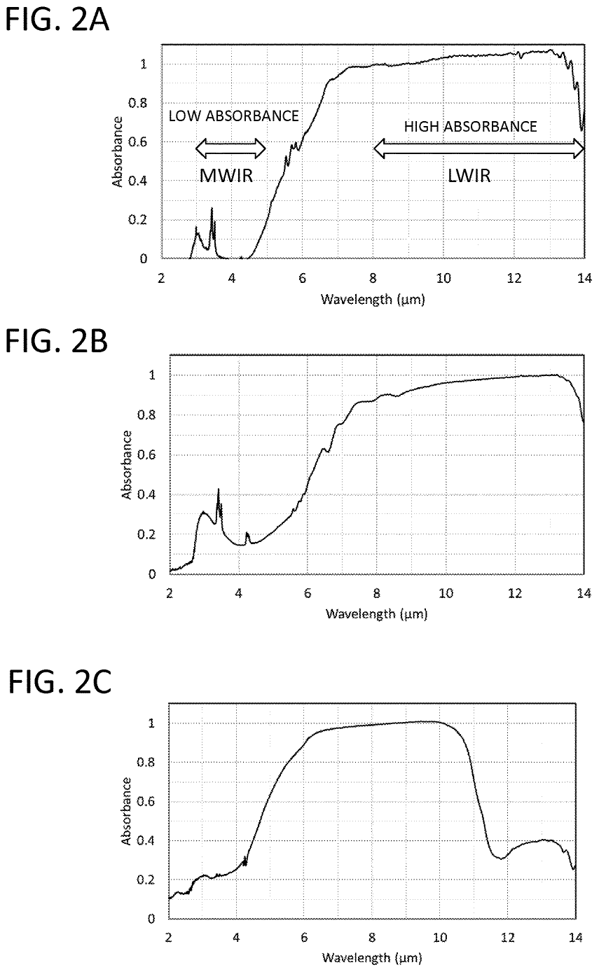

FIG. 2A shows an example of the absorption spectrum of an ytterbium gallium garnet Yb₃Ga₅O₁₂ sintered body. It can be seen that absorbance is high in the LWIR band but low in the MWIR band.

FIG. 2B shows an example of the absorption spectrum of an erbium gallium garnet Er₃Ga₅O₁₂ sintered body. The absorbance is low in the MWIR band and high in the LWIR band.

FIG. 2C shows an example of the absorption spectrum of an Al₂O₃ sintered body. The absorbance is low in the MWIR band. In the LWIR band, the absorbance decreases at wavelength of 11 μm and above.

Third absorber group, as the third absorber group absorbing both the MWIR and LWIR bands, includes conductive nanocarbon material films (such as fullerene or non-chirality-controlled metallic-type CNTs). Carbon materials may be suitably used, or gray body materials such as silicon carbide (SiC) may also be used.

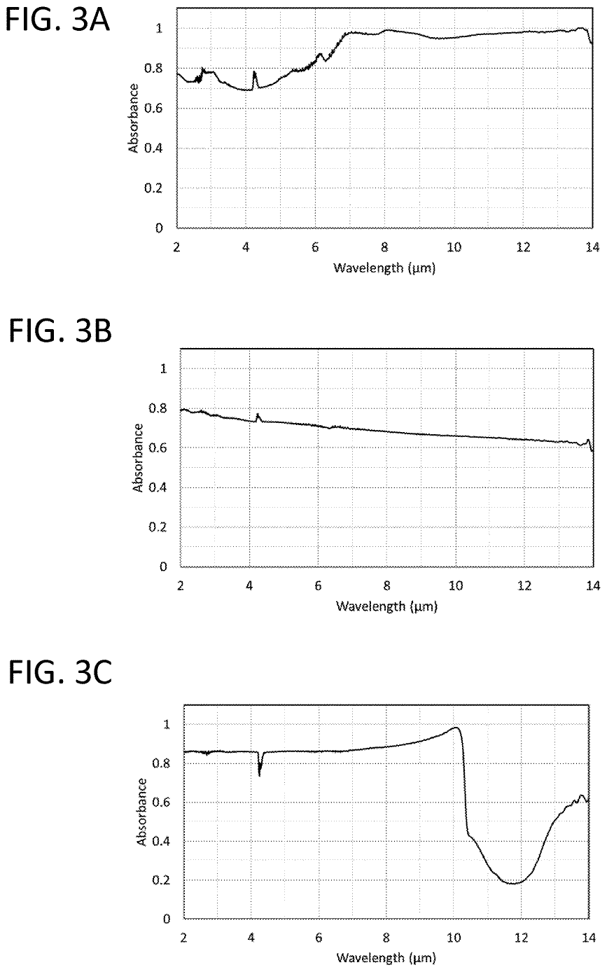

FIG. 3A shows an example of the absorption spectrum of a blackbody-coated SiC sintered body. The blackbody coating is JSC-3 manufactured by Japan Sensor Corporation, with main components including SiZrO₄, Cr₂O₃, and iron oxide-based inorganic pigments. The blackbody-coated SiC sintered body exhibits high absorbance across the entire MWIR and LWIR bands, particularly high in the LWIR band.

FIG. 3B shows an example of the absorption spectrum of a graphite sintered body. The absorbance ranges from 0.6 to 0.8 across all wavelengths in the MWIR and LWIR bands.

FIG. 3C shows an example of the absorption spectrum of a SiC sintered body. The absorbance is high in the MWIR band, while the absorbance decreases at wavelength of 10.5 μm and above in the LWIR band. Since the peak wavelength of thermal radiation near room temperature is around 10 μm, an effective LWIR wavelength range of approximately 8 to 10 μm is sufficient.

The first absorber group (MWIR selective absorption material) and the second absorber group (LWIR selective absorption material) may include composites with resins or similar materials. When a composite with resin is used, excellent compatibility with printed devices is established, enabling the formation of each absorption material via printing.

Regarding the first absorption layer 1 and the second absorption layer 2, the following examples can be listed as combinations of the first to third absorber groups.

TABLE 1

| Combination | Second absorption layer 2 | First absorption layer 1 |
|---|---|---|
| A | (1)First absorber group: absorbing MWIR | (3)Third absorber group: absorbing both MWIR and LWIR |
| B | (1)First absorber group: absorbing MWIR | (2)Second absorber group: absorbing LWIR |
| C | (2)Second absorber group: absorbing LWIR | (3)Third absorber group: absorbing both MWIR and LWIR |
| D | (2)Second absorber group: absorbing LWIR | (1)First absorber group: absorbing MWIR |

In FIG. 1, the second absorption layer 2 may be configured such that its infrared absorption spectrum exhibits strong absorption at specific wavelengths (bandwidths).

In FIG. 1, the wavelength band absorbed by the second absorption layer 2 does not reach the first absorption layer 1 positioned directly below the second absorption layer 2. Therefore, the first absorption layer 1 may be provided with a high absorbance in at least a wavelength band different from that of the second absorption layer 2. Furthermore, the first absorption layer 1 may also have broad absorption characteristics spanning both the LWIR and MWIR wavelength bands.

In FIG. 1, when an unillustrated protective film, which also serves as a base material for a diaphragm including the second absorption layer 2, exhibits absorption at a specific wavelength, the second absorption layer 2 may be configured to absorb a band to which that specific wavelength belongs. When the unillustrated protective film, which also serves as the base material for the diaphragm including the second absorption layer 2, is, for example, a silicon nitride (SiN) film, exhibiting absorption around a wavelength of approximately 10 μm, likely due to Si—N group, it is possible to configure the second absorption layer 2 to absorb the LWIR band using the second absorber group. In this case, combinations C and D in Table 1 may be considered preferable.

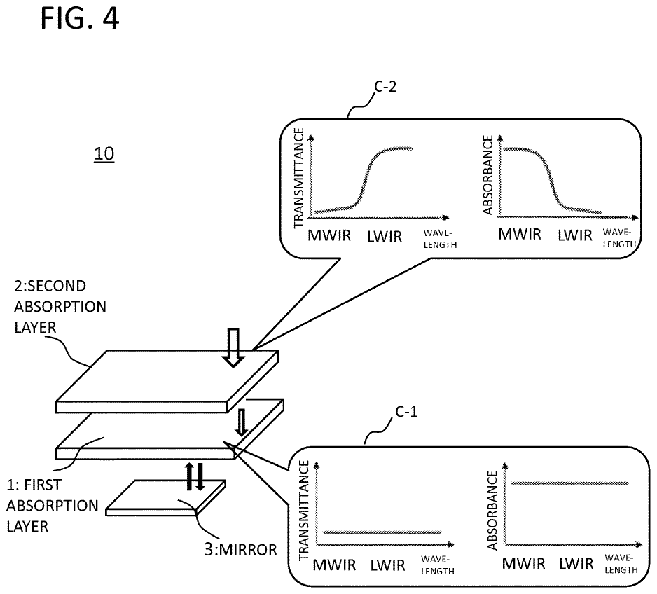

FIGS. 4 through 7 schematically illustrate combinations A, B, C, and D of the first absorber group to third absorber group listed in Table 1 for the first absorption layer 1 and second absorption layer 2 shown in FIG. 1.

In the example of FIG. 4, the second absorption layer 2 exhibits high absorption (low transmittance) in the MWIR band and high transmittance (low absorbance) in the LWIR band, as illustrated in a rounded rectangular callout C-2 by its absorption spectrum (wavelength on the horizontal axis, absorbance on the vertical axis) and transmittance spectrum (wavelength on the horizontal axis, transmittance on the vertical axis). The first absorption layer 1 exhibits high absorbance (low transmittance) in both the MWIR and LWIR bands as illustrated in a rounded rectangular callout C-1.

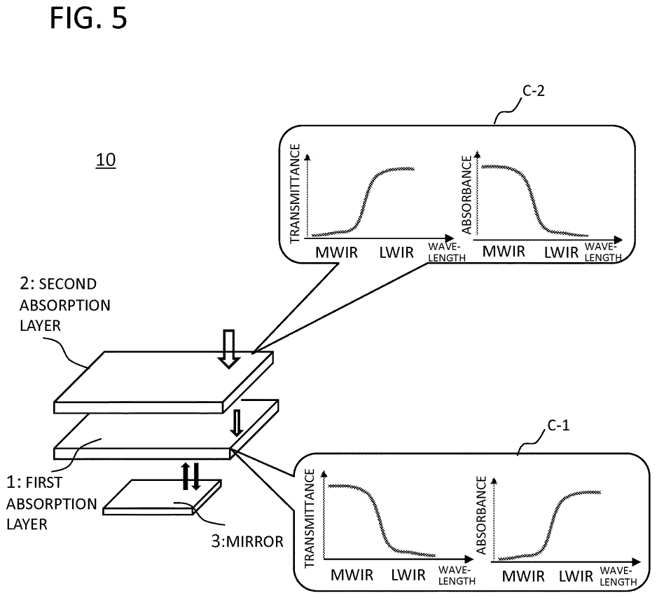

In the example of FIG. 5, the second absorption layer 2 exhibits high absorbance (low transmittance) in the MWIR band and high transmittance (low absorbance) in the LWIR band, as shown by the absorption and transmittance spectra illustrated in as illustrated in a rounded rectangular callout C-2. The first absorption layer 1 exhibits high absorbance (low transmittance) in the LWIR band and low absorbance (high transmittance) in the MWIR band as illustrated in a rounded rectangular callout C-1.

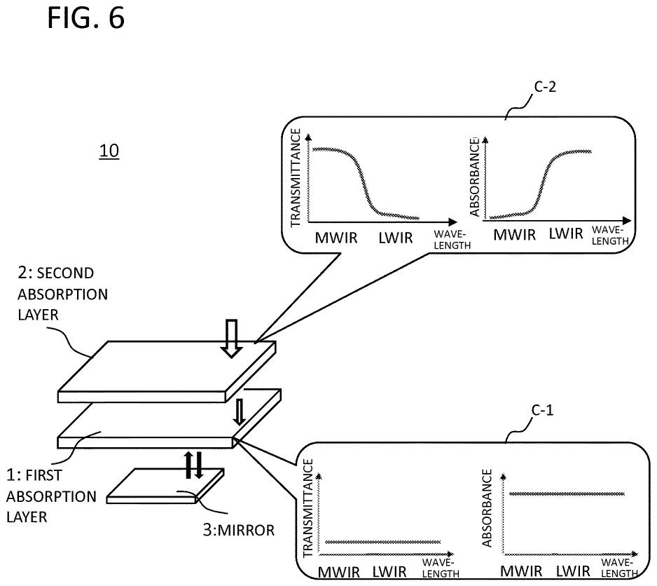

In the example of FIG. 6, the second absorption layer 2 exhibits high absorbance (low transmittance) in the LWIR band and high transmittance (low absorbance) in the MWIR band, as shown by the absorption and transmittance spectra illustrated in a rounded rectangular callout C-2. The first absorption layer 1 exhibits high absorbance (low transmittance) in both the MWIR and LWIR bands as illustrated in a rounded rectangular callout C-1.

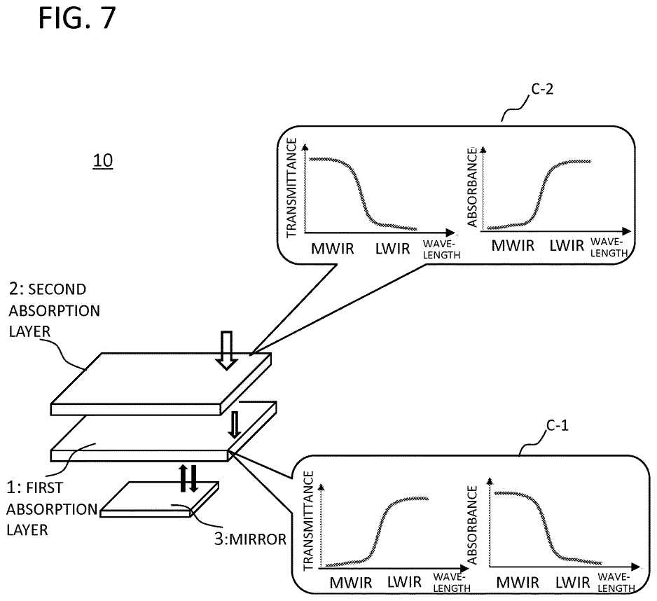

In the example of FIG. 7, the second absorption layer 2 exhibits high absorbance (low transmittance) in the LWIR band and high transmittance (low absorbance) in the MWIR band, as shown by the absorbance and transmittance spectra illustrated in a rounded rectangular callout C-2. The first absorption layer 1 exhibits high absorbance (low transmittance) in the MWIR band and low absorbance (high transmittance) in the LWIR band as illustrated in a rounded rectangular callout C-1.

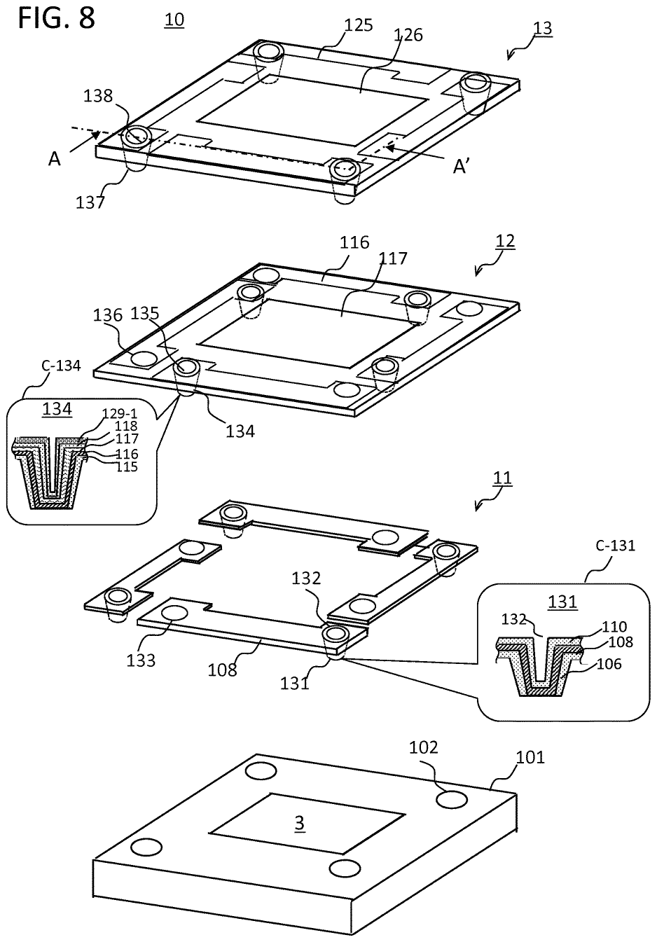

FIG. 8 is an example diagram illustrating several embodiments of the present disclosure, and is an exploded perspective view schematically illustrating an example of the wiring structure (electrode wiring structure) of the cell 10 shown in FIG. 1. Referring to FIG. 8, contact electrodes 102 are provided on corners of a surface of a substrate 101. A mirror 3 is provided on a surface of the substrate 101. The substrate 101 may be a ROIC (Read Out Integrated Circuit) substrate equipped with a readout circuit (not shown) for a bolometer-type infrared detector. In this case, the substrate 101 may be a silicon (Si) substrate.

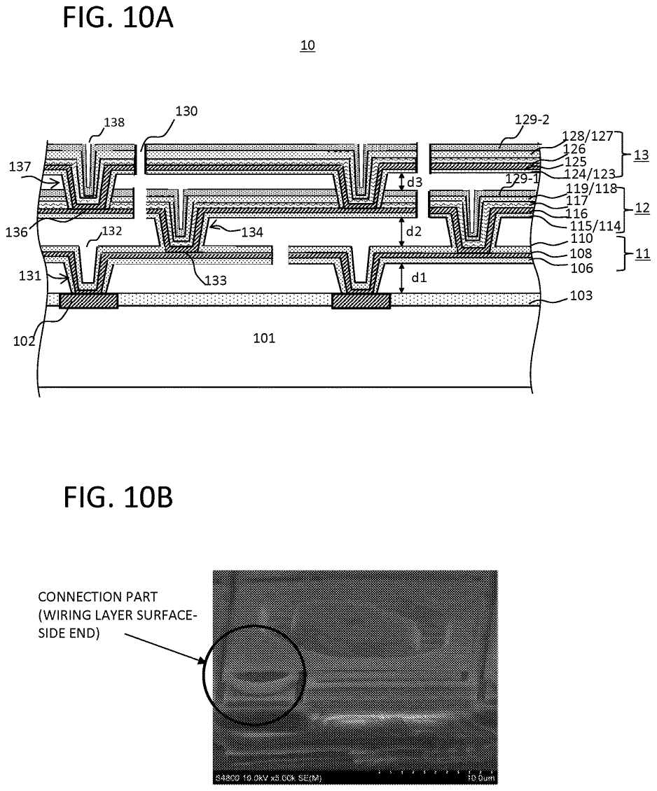

The cell 10 includes a first wiring metal 108 as a first layer 11 (first wiring layer) positioned above the substrate 101 and facing the substrate 101. The first wiring metal 108 includes a connection part 131 mechanically and electrically in contact with a contact electrode 102 on the surface of the substrate 101. The connection part 131 may be configured to have a protrusion with one end (tip) in contact with a surface of the contact electrode 102 on the substrate 101. The connection part 131 protruding toward the substrate 101 may be configured as a recess when viewed from a surface side of the first wiring metal 108. At the connection part 131, the surface side of the first wiring metal 108 corresponds to an open end 132 of the recess. FIG. 8 schematically shows an example of the cross-sectional configuration of the connection part 131 in a rounded rectangular callout C-131 (see FIG. 10A). As illustrated in a rounded rectangular callout C-131, a base protective film 106 underlies the first wiring metal 108. A protective film 110 (passivation film) is provided on the first wiring metal 108 to cover the first wiring metal 108 and an outer edge thereof. At the connection part 131, the first wiring metal 108, together with the underlying protective film 106 and the surface-side protective film 110, is recessed downward from an edge of the open end 132 and contacts the surface of the contact electrode 102 on the substrate 101. The protective film 106 corresponding to a position of the contact electrode 102 is etched away, allowing a surface of the contact electrode 102 to be made in contact with the first wiring metal 108. That is, one end (bottom) of the connection part 131 that contacts the contact electrode 102 of the substrate 101 includes a laminated structure of the first wiring metal 108 and the protective film 110 laminated thereon.

In FIG. 8, a contact area 133 on the first wiring metal 108 is an area where one end of a connection part 134 of a wiring layer of a second layer 12 contacts the first wiring metal 108. It is noted that a metal bump to connect to the first wiring metal 108 may be formed on the contact electrode 102 of the substrate 101. In this case, the connection part 131 of the first wiring metal 108 is not required. The mirror 3 on the substrate 101 may be formed as wiring patterned together with the contact electrode 102 on the surface of the substrate 101.

Above the first layer 11, the second layer 12 includes a patterned second wiring metal 116 and a first CNT film 117. The first CNT film 117 may be configured to cover an area on the second wiring metal 116 and an area between patterns or between electrodes of the second wiring metal 116. The pattern shape of the second wiring metal 116 may be, for example, comb-shaped, interdigitated, or meandered, as described later. The first CNT film 117 may have a CNT network configuration (two-dimensional network) corresponding to a pattern shape of the second wiring metal 116 directly beneath it. A resistance of a semiconductor-type CNT between opposing two electrodes (two-terminal resistance) varies with spacing (gap) between the opposing two electrodes (channel length). The spacing between the opposing two electrodes is preferably, for example, from 0.1 μm (micrometer) to 50 μm, and for miniaturization, for example, from 0.5 μm to 5 μm is more preferable, though not particularly limited thereto.

In the second layer 12, the connection part 134 may be formed as a protrusion with one end in contact with a contact area 133 of the first wiring metal 108 in the first layer 11. The connection part 134 protruding toward the first wiring metal 108 is configured as a recess when viewed from a surface side of the second wiring metal 116. At the connection part 134, the surface side of the second wiring metal 116 forms an open end 135 of the recess. An example of the cross-sectional configuration of the connection part 134 is schematically shown in a rounded rectangular callout C-134 (see also FIG. 10A). A protective film 115 underlies the second wiring metal 116. On the second wiring metal 116, at least a first CNT film 117, a protective film 118, and a first absorption film 129-1 corresponding to the first absorption layer 1 are laminated. The protective film 118 on the first CNT film 117 may include multiple layers. The second wiring metal 116, together with the underlying protective film 115, the first CNT film 117, the protective film 118, and the first absorption film 129-1, is recessed downward from an edge of the open end 135 to contact with the contact area 133 of the first wiring metal 108. In the connection part 134, the protective film 115 corresponding to the position of the contact area 133 is etched away, allowing the second wiring metal 116 to be in contact with the contact area 133 of the first wiring metal 108. That is, one end (bottom) of the connection part 134 includes a laminated structure of the second wiring metal 116, the first CNT film 117, the protective film 118, and the first absorption film 129-1 laminated in order.

In FIG. 8, a contact area 136 is an area to which one end of a connection part 137 of a wiring layer of a third layer 13 contacts. A bump connecting to the second wiring metal 116 of the second layer 12 may be formed on the side of the first wiring metal 108 of the first layer 11. In this case, the connection part 134 of the second wiring metal 116 is not required.

The third layer 13 includes a patterned third wiring metal 125 and a second CNT film 126 configured to cover an area above the patterned third wiring metal 125 and areas between patterns (and between electrodes). A pattern shape of the third wiring metal 125 of the third layer 13 may be, for example, comb-shaped, interdigitated, or meandered, as described later. The second CNT film 126 may have a CNT network configuration corresponding to the pattern shape of an area(s) between the electrodes of the third wiring metal 125. Although not particularly limited, the spacing between electrodes is preferably, for example, from 0.1 μm (micrometer) to 50 μm, and for miniaturization, for example, from 0.5 to 5 μm is more preferable. As will be described later, the two-dimensional pattern shapes of the third wiring metal 125 and the second wiring metal 116 may have overlapping portions when viewed from above.

In the third layer 13, the connection part 137 may be formed as a protrusion that contacts the contact area 136 of the second wiring metal 116 of the second layer 12. The connection part 137 protruding toward the second wiring metal 116 side is configured as a recess when viewed from a surface side of the third wiring metal 125. At the connection part 137, the surface side of the third wiring metal 125 forms an open end 138 of the recess. The cross-sectional shape of the connection part 137 is the same as that of the connection part 134 (FIG. 10A). A bump for connecting the third wiring metal 125 may be formed on the second wiring metal 116 side of the second layer 12. In this case, the connection part 137 of the third wiring metal 125 is not required. An unillustrated second absorption layer 2 may be formed on the second CNT film 126 via an unillustrated protective film (passivation film).

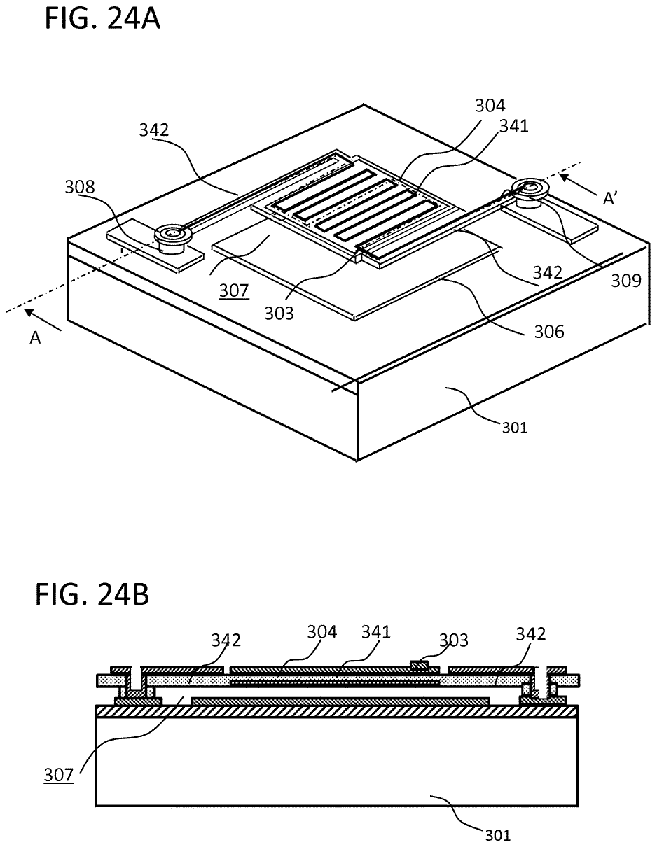

Semiconductor-type CNTs are preferably used as the first CNT film 117 and the second CNT film 126. A temperature coefficient of resistance (TCR) of the semiconductor-type CNT is about three times or more that of vanadium oxide in the bolometer film shown in FIG. 24, achieving high sensitivity in the bolometer-type infrared detector.

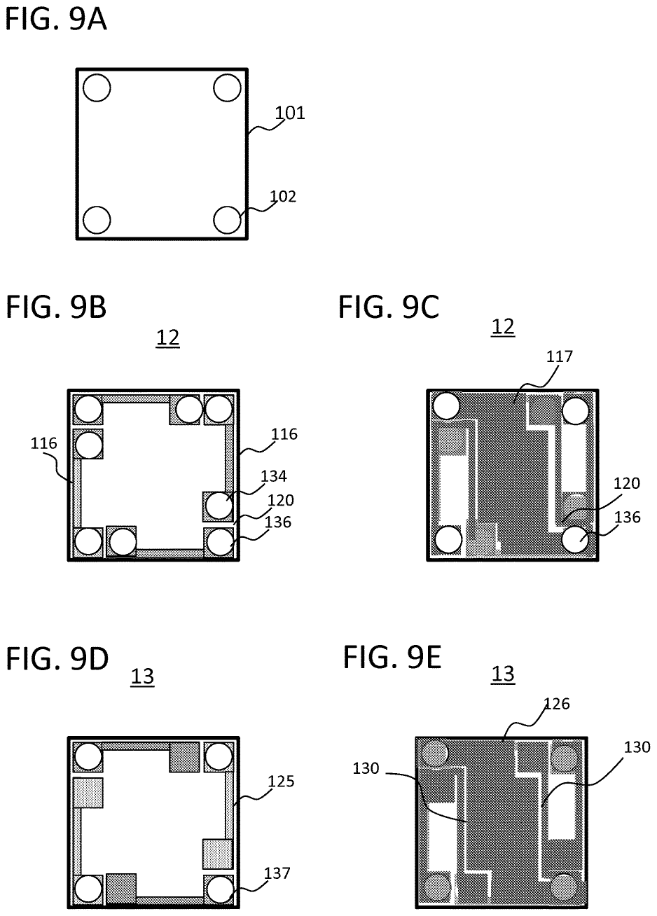

FIGS. 9A-9E are schematic diagrams illustrating the wiring patterns (partial) of each layer in FIG. 8. FIG. 9A is a schematic plan view of the substrate 101 in FIG. 8 as seen from above. FIG. 9B is a schematic plan view illustrating an example of the wiring layer of the second layer 12 in FIG. 8. FIG. 9C is a schematic plan view illustrating the pattern of the first CNT film 117 formed on the wiring layer of the second layer 12 of FIG. 9B. The first CNT film 117 may cover a predetermined area on the second wiring metal 116, excluding the contact area 136 that is to be in contact with the third wiring metal 125 of the third layer 13 and alit (first slit) 120. FIG. 9D is a schematic plan view illustrating an example of a wiring layer as seen from above the third layer 13 of FIG. 8. FIG. 9D is a schematic plan view illustrating an example of a pattern of the second CNT film 126 formed on the third layer 13. The second CNT film 126 may cover a predetermined area (the entire surface) on the third wiring metal 125, excluding slits (second slits) 130.

FIG. 10A is a schematic diagram illustrating an example of a cross-section along line A-A′ in FIG. 8. For simplicity, FIG. 10 shows the first to third wiring metals 108, 116 and 125 as wiring layers, and the cross-sections of the wiring patterns (comb-shaped, finger-like electrodes) are omitted. Furthermore, in FIG. 10A, to illustrate an example of the laminated structure (vertical direction) of each layer, the laminated structure is shown enlarged relative to the horizontal dimensions.

Referring to FIG. 10A, the first layer 11 includes a laminated structure including the base protective film 106, the first wiring metal 108, and the protective film 110 that covers the patterned first wiring metal 108 and an outer edge (end face) thereof. The connection part 131 (first connection part) is configured as a protrusion in which the first wiring metal 108 protrudes toward the substrate 101, with one end (tip) made in contact with the contact electrode 102 on the substrate 101. Viewed from a surface side of the first wiring metal 108, the connection part 131 forms a cup-shaped recess, with the surface side of the first wiring metal 108 being an open end 13, wherein the cup-shaped recess is like an open-topped hollow cylinder with a bottom. A sidewall of the connection part 131, from an outer side, includes the protective film 106, the first wiring metal 108, and the protective film 110. At one end of the connection part 131 (i.e., a tip of a protrusion, a bottom of the recess), the protective film 106 is etched away, allowing the first wiring metal 108 to contact with the contact electrode 102 on the substrate 101, forming a two-layer structure consisting of the first wiring metal 108 and the protective film 110. The connection part 131 serves not only as an electrical connection to the contact electrode 102 of substrate 101, but also as a support member to support the first layer 11 at a predetermined height d1 above the surface of the substrate 101. Note that in FIG. 10A, the connection part 131 is shown as a cantilever type support member, in which an object to be supported is anchored or fixed at only one end, while the other end remains free, but it may, as a matter of course, also be configured as a double-ended support structure in which both ends are anchored or fixed. As the protective films 106 and 110, which serve as passivation films, silicon nitride (SiN) or the like may be used with moisture resistance, heat resistance, mechanical strength, and chemical stability taken into account. By using silicon nitride (SiN) as the protective films 106 and 110, the first layer 11 is enabled to be supported overhead the substrate 101.

The second layer 12 includes a protective film 115/114, the second wiring metal 116, the first CNT film 117, a protective film 119/118, and a first absorption film 129-1. The protective film 115/114 designates laminated films in which a protective film 115 is laminated on top of a protective film 114. The connection part 134 (second connection part) is configured as a protrusion including the second wiring metal 116 protruding toward the first wiring metal 108 directly below, with one end (tip) in contact with the first wiring metal 108. Viewed from the surface side of the second wiring metal 116, the connection part 134 forms a cup shaped recess, where the surface side of the connection part 134 forms an open end 135. The sidewall of the connection part 134 includes, from an outer side, the protective film 115/114, the second wiring metal 116, the first CNT film 117, the protective film 119/118, and the first absorption film 129-1. At one end (the tip of the protrusion, the bottom of the recess) of the connection part 134, the protective film 115/114 is etched away, allowing the second wiring metal 116 to contact with the contact area 133 of the first wiring metal 108. The second wiring metal 116, the first CNT film 117, the protective film 119/118, and the first absorption film 129-1 form a laminated structure. The connection part 134 electrically connects the second wiring metal 116 of the second layer 12 to the contact area 133 of the first wiring metal 108 of the first layer 11, and also serves as a support member to support the second layer 12 positioned at a predetermined height d2 above the first layer 11. Furthermore, the protective films 115/114 and 119/118, which may be silicon nitride (SiN) or the like, serve as support elements to support the second layer 12 overhead the first layer 11.

The third layer 13 includes a protective film 124/123, a third wiring metal 125, a second CNT film 126, a protective film 128/127, and a second absorption film 129-2 corresponding to the second absorption layer 2. A connection part 137 (third connection part) is configured as a protrusion including the third wiring metal 125 protruding toward the second wiring metal 116 directly below, with one end (tip) in contact with the second wiring metal 116. The connection part 137 is configured as a cup-shaped (bowl-shaped) recess when viewed from the surface side of the third wiring metal 125, a surface side thereof being an open end 138. A sidewall of the connection part 137 includes, from an outer side, the protective film 124/123, the third wiring metal 125, the second CNT film 126, the protective film 128/127, and the second absorption film 129-2. At one end of the connection part 137 (the tip of the protrusion, the bottom of the recess), the protective film 124/123 is etched away, wherein the third wiring metal 125 contacts the contact area 136 of the second wiring metal 116, forming a laminated structure including the third wiring metal 125, the second CNT film 126, the protective film 128/127, and the second absorption film 129-2. The connection part 137 electrically connects the third wiring metal 125 of the third layer 13 to the contact area 136 of the second wiring metal 116 of the second layer 12, and also serves as a support member to support the third layer 13 at a predetermined height d3 above the surface of the wiring layer of the second layer 12. The protective films 124/123 and 128/127, which may be silicon nitride (SiN) or the like, serve as support members to support the third layer 13 overhead the second layer 12. The first absorption film 129-1 of the second layer 12 and the second absorption layer 129-2 of the third layer 13 may be appropriately selected from the combinations A, B, C, and D in the Table 1.

FIG. 10B shows an SEM (Scanning Electron Microscope) image of the connection part in a reference example. Note that FIG. 10B is not an SEM image of the connection part 131 in FIG. 10A, but an SEM image of a concave-shaped (bowl-shaped) connection part with a bottom thereof in contact with a contact. An area close to the open end 132 of the connection part 131 on a surface-side of the first layer 11 may have irregularities reflecting those of a contact such as the contact electrode 102 which is in contact with a bottom of the connection part 131 and does not necessarily become flat. If a connection part of an upper layer (2nd layer 12) is to be formed directly on the area close to the open end 132, the structure of the connection part may become distorted, potentially leading to a reduction in strength. Therefore, the connection part 134 of the second layer 12 is arranged spaced apart from and not overlapped with the connection part 131 of the first layer 11.

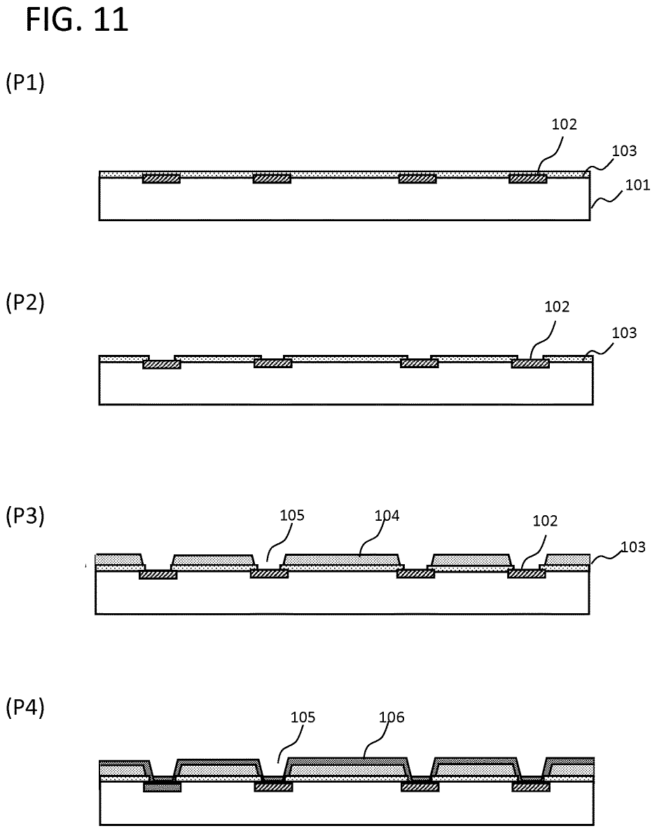

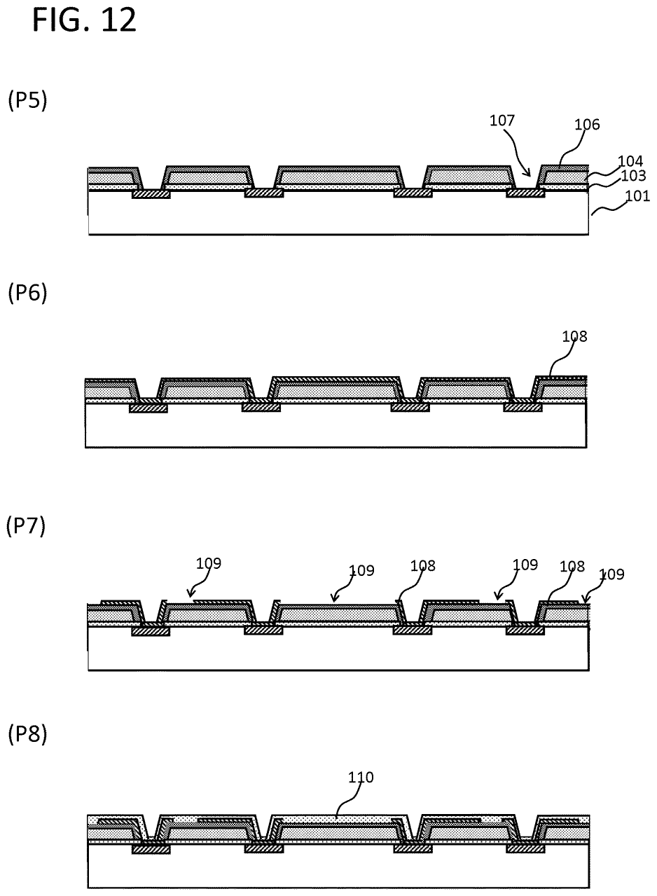

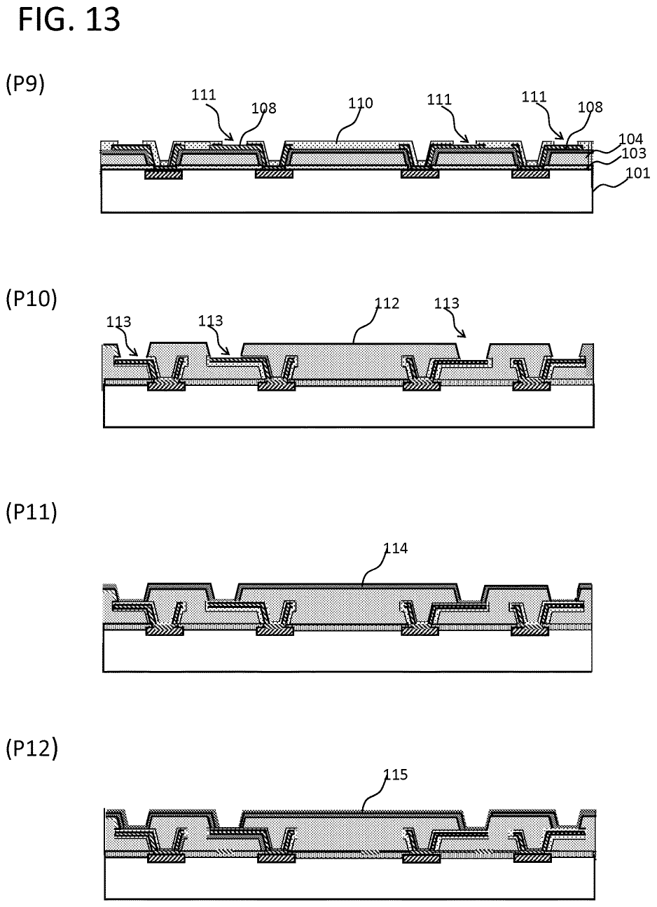

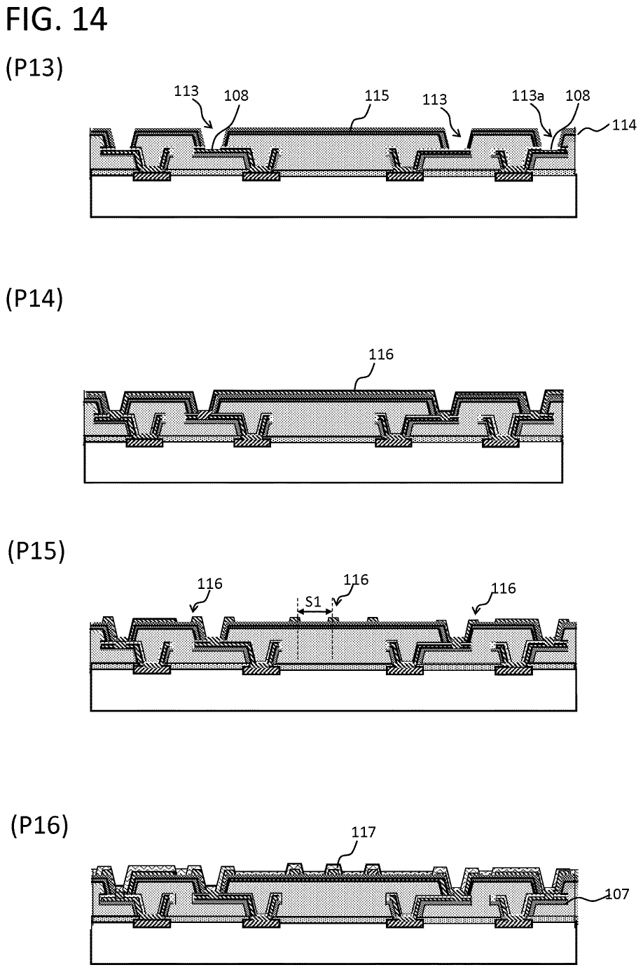

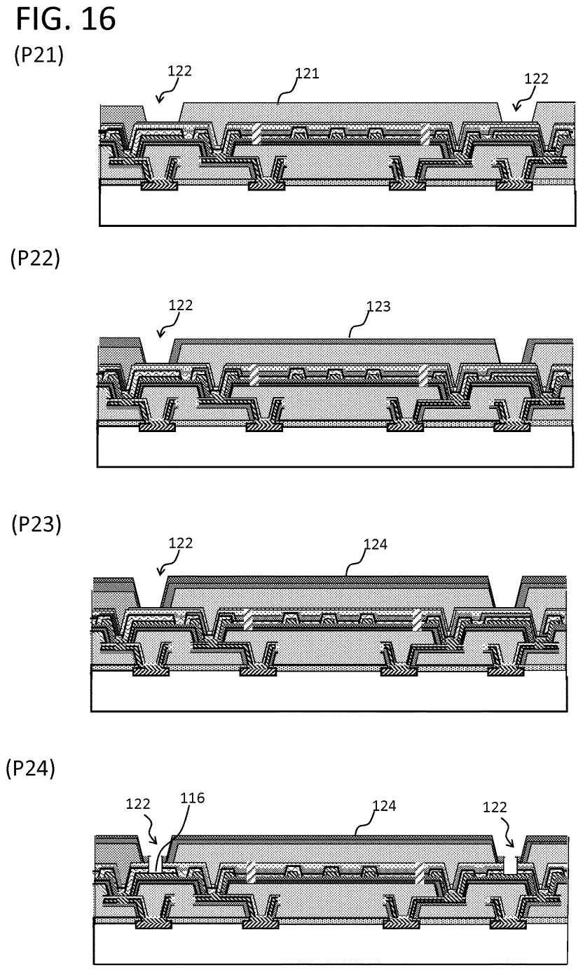

Such a microstructure including lower and upper electrodes with a cavity therebetween may be generally fabricated using a sacrificial layer. For example, a sacrificial layer is formed on a lower electrode, subsequently an upper electrode may be formed on the sacrificial layer, and then the sacrificial layer may be selectively removed to produce a three-dimensional electrode structure with lower and upper electrodes mutually opposed via a cavity. The configuration illustrated in FIG. 10A may be fabricated, for example, as follows (but is not limited to the following).
(a) Forming a first sacrificial layer (104: (P3) of FIG. 11) on the protective film 103 having an opening over the contact electrode 102 on the substrate 101 and patterning the first sacrificial layer to form a first opening (105: (P3) of FIG. 11) reaching the contact electrode 102.
(b) Depositing the protective film 106 over the first sacrificial layer (104: P3 of FIG. 11) and patterning the protective film 106 to form a second opening (107: (P5) of FIG. 12) reaching the contact electrode 102.
(c) Depositing a first conductive film on the protective film 106 and patterning the first conductive film to form a first wiring layer (first wiring metal) 108.
(d) Depositing the protective film 110 on the first wiring layer (first wiring metal) 108 and patterning the protective film 110 to form a third opening (111: (P9) of FIG. 13) where a part of a surface of the first wiring layer (first wiring metal) 108 is exposed at the first contact area (connection position) 133 to contact with the second wiring layer (second wiring metal) 116.
(e) Forming a second sacrificial film (112: (P10) of FIG. 13) on the protective film 110 and patterning the second sacrificial film to form a fourth opening (113: (P10) of FIG. 13) with a diameter smaller than the third opening (111: (P9) of FIG. 13) at the first contact area (connection position) 133 to contact with the second wiring layer 116.
(f) Depositing a protective film 114 on the second sacrificial layer and patterning the protective film 114 to form a fifth opening (113: (P13) of FIG. 14) with a smaller diameter than the fourth opening at the first contact area (connection position) 133 to contact with the second wiring layer (second wiring metal) 116.
(g) Depositing a second conductive film on the protective film 114/115 and patterning the second conductive film to form the second wiring layer (second wiring metal) 116.
(h) Depositing the first CNT film 117, the protective film 119/118, and the first absorption film 129-1 having a first absorption wavelength spectrum on the second wiring layer (second wiring metal) 116.
(i) Forming a third sacrificial layer (121: (P21) of FIG. 16) on the first absorption film 129-1 and patterning the third sacrificial layer to form a sixth opening (122: (P21) of FIG. 16) where a part of the surface of the second wiring layer (second wiring metal) 116 is exposed at the second contact area (connection position) 136 to contact with the third wiring metal 125.
(j) Depositing the protective film 124/123 over the third sacrificial layer and patterning the protective film to form a seventh opening (122: (P24) of FIG. 16) with a smaller diameter than the sixth opening at the second contact area (connection position) 136 to contact with the second wiring layer (second wiring metal) 116.
(k) Depositing a third conductive film on the protective film 124/123 and patterning the third conductive film to form the third wiring metal 125.
(l) Laminating, on the third wiring metal 125, the second CNT film 126, the protective film 128/127, and the second absorption film 129-2 having a second absorption wavelength spectrum.
(m) By selectively removing the first sacrificial layer (104), the second sacrificial layer (112), and the third sacrificial layer (121), the first connection part 131 is formed such that one end of which contacts the contact electrode 102 of the substrate 101 to ensure electrical connection between the contact electrode 102 and the first wiring layer 108, while also supporting the first wiring layer 108 from below to be maintained at a predetermined distance from the substrate 101, the second connection part 134 is formed such that one end of which contacts the first connection position 133 of the first wiring layer 108 to ensure electrical connection between the first wiring layer 108 and the second wiring layer 116, while also supporting the second wiring layer 116 from below to be maintained at a predetermined distance from the first wiring layer 108 and the third connection part 137 is formed such that one end of which contacts the second connection position 136 on the second wiring layer 116 to ensure electrical connection between the second wiring layer 116 and the third wiring metal 125, while supporting the third wiring metal 125 from below to be maintained at a predetermined distance from the second wiring layer 116.

FIGS. 11 through 18 schematically illustrate examples of fabrication process steps for a MEMS device of the present disclosure described with reference to FIGS. 8 through 10A. Each figure schematically shows a cross-section of one cell (pixel) in a representative sequence of process steps. Note that in FIGS. 11 through 18, reference numbers may be assigned to an element(s) processed in a relevant step, the convenience′ sake of drawing.

### <Process 1: (P1) in FIG. 11>

A conductive film is deposited over an entire light-receiving area (two-dimensional cell array) of a substrate 101. Using a mask, the conductive film is etched to form a pattern to create a wiring pattern that includes contact electrodes (electrode pads) 102. The conductive film may include materials, such as aluminum (Al). Gold (Au), platinum (Pt), titanium (Ti), or alloys primarily composed of these materials may also be used. The substrate 101 may be a silicon (Si) substrate processed from, for example, a silicon wafer. A readout circuit (not shown) may be formed on the substrate 101. A protective film 103 is formed on the substrate 101. The protective film 103 may be, for example, a thermal oxide film (SiO₂). Alternatively, it may be a silicon nitride film (Si₃N₄ (SiN)) formed on the substrate 101, for example, by a method such as CVD (Chemical Vapor Deposition). The thickness of the contact electrode 102 is not particularly limited but may be in the range of several tens of nm (nanometers) to about 5 μm. The thickness of the protective film 103 is not particularly limited but may be, for example, in the range of about nm to 5 μm.

### <Process 2: (P2) in FIG. 11: First Etching of Cell Contact>

Using a mask, the protective film 103 is etched away to form an opening exposing the surface of the contact electrodes 102. When the protective film 103 is a silicon nitride film, the etching may use, for example, dry etching employing fluorine-based gases. Alternatively, etching solutions such as buffered hydrogen fluoride (BHF) or hydrofluoric acid may be used.

### <Process 3: (P3) in FIG. 11: Formation of First Sacrificial Layer>

Form a first sacrificial layer 104 on the light-receiving area of the substrate 101. A sacrificial layer refers to a layer formed with an intention of being removed in a subsequent process. The first sacrificial layer 104 may be photosensitive polyimide (PI). In this case, a polyimide sacrificial layer may be formed by, for example, applying a resin composition as the sacrificial layer, via spin coating or screen printing etc., drying at, for example, 100 to 150 °C, and then performing a thermal curing treatment continuously or intermittently at, for example, 200 to 500 °C for 1 to 3 hours. The polyimide may be uniformly spin-coated to a predetermined film thickness (e.g., 500 nm (nanometers) to 50 μm). Note that the first sacrificial layer 104 may also be a silicon oxide film. The silicon oxide film may be deposited by sputtering, CVD (chemical vapor deposition), spin-coating, etc.

A thickness of the first sacrificial layer 104 defines a distance (d1 in FIG. 10A) between a surface of the substrate 101 and the first wiring metal 108.

For example, by transferring a pattern onto the first sacrificial layer 104 (photosensitive polyimide) by exposure and selectively dissolving the layer with a developing solution, an opening 105 is formed on the contact electrode 102, with the surface thereof being exposed. The opening 105 may have a tapered side wall rather than a vertical one. When the first sacrificial layer 104 is made of a silicon oxide film, dry etching may be used. Alternatively, wet etching using, for example, BHF (buffered hydrofluoric acid solution) may be used.

### <Process 4: (P4) in FIG. 11: Formation of First Sacrificial Layer Protective Film>

The first sacrificial layer 104 is covered with the first sacrificial layer protective film 106. The protective film (first sacrificial layer protective film) 106 covering the first sacrificial layer 104 may be, for example, a silicon nitride film deposited by CVD. The first sacrificial layer protective film 106 may serve to prevent structural collapse of the first sacrificial layer 104, such as a sidewall of the opening 105. The first sacrificial layer protective film 106 serves as an underlying protective film (passivation film) of the first wiring metal 108 formed in the subsequent process 6 and also acts as a support substrate for the first layer (11 in FIG. 10A). The film thickness of the first sacrificial layer protective film 106 may be, for example, approximately nm to 5 μm.

### <Process 5: (P5) in FIG. 12: Second Etching of Cell Contact>

Using a mask, the first sacrificial layer protective film 106 and the first sacrificial layer 104 are selectively etched to form a opening 107 to expose a surface of the contact electrodes 102. The etching of the silicon nitride film may be performed by dry etching.

### <Process 6: (P6) in FIG. 12: First Wiring Metal Deposition>

Deposit a conductive film (first wiring metal 108) on the first sacrificial layer protective film 106. Material of the conductive film for the first wiring metal 108 is not particularly limited, but may be, for example, a titanium alloy (Ti6Al4V: Titanium Aluminum Vanadium: TAV). The method for forming the first wiring metal 108 may, though not particularly limited thereto, include evaporation, sputtering, or printing. The film thickness of the first wiring metal 108 may be, for example, 10 nm to 10 μm, preferably 100 nm to 1 μm.

### <Process 7: (P7) in FIG. 12: Etching of First Wiring Metal>

Using a mask, the conductive film of the first wiring metal 108 is selectively etched to remove an unnecessary area(s), such as an area 109 of the conductive film of the first wiring metal 108. The etching may be dry etching. In dry etching of titanium-based alloys, etch termination detection may be performed using plasma emission, ion mass spectrometry, laser film thickness gauges, etc., but not limited thereto. Alternatively, wet etching may also be used.

### <Process 8: (P8) in FIG. 12: Formation of First Metal Protective Film>

A protective film (first wiring metal protective film) 110 is formed to cover an entire surface (top surface and outer edge) of the patterned first wiring metal 108. The first wiring metal protective film 110 may be formed, for example, by depositing a silicon nitride (SiN) film using a CVD method. The first wiring metal protective film 110, which serves as the passivation film, also serves as a support substrate for the first layer (11 in FIG. 10A). A film thickness of the first wiring metal protective film 110 may be, for example, approximately 10 nm to 5 μm.

### <Process 9: (P9) in FIG. 13: Etching of First Contact>

Using a mask, the first wiring metal protective film 110 is selectively etched to form an opening in a contact area 111 (the contact area 133 in FIG. 8) in which the surface of the first wiring metal 108 is exposed. The etching may be either dry etching or wet etching.

### <Process 10: (P10) in FIG. 13: Formation of Second Sacrificial Layer>

A second sacrificial layer 112 is formed to cover the first wiring metal protective film 110. The second sacrificial layer 112 may be formed, for example, by spin coating a polyimide resin (photosensitive polyimide). Alternatively, a silicon oxide film may be used as the second sacrificial layer 112. A thickness of the second sacrificial layer 112 defines a distance (d2 in FIG. 10A) between the first layer 11 and the second layer 12. The thickness of the second sacrificial layer 112 may be, for example, approximately 10 nm to 5 μm. The second sacrificial layer 112 (photosensitive polyimide) is exposed and developed to form an opening 113 over the contact area 111 in which the surface of the contact area 111 on the first wiring metal 108 is exposed. The opening 113 may have a sidewall tapered rather than vertical. For silicon oxide film, dry etching may be used. Alternatively, wet etching using, for example, BHF (buffered hydrofluoric acid solution) may be used.

### <Process 11: (P11) in FIG. 13: Formation of Second Sacrificial Layer Protective Film>

As a protective film (second sacrificial layer protective film) 114 for the second sacrificial layer 112, a silicon nitride film or the like is deposited on the second sacrificial layer 112, for example by CVD. A film thickness may be, for example, approximately 10 nm to 5 μm.

### <Process 12: (P12) in FIG. 13: Formation of the First CNT Lower Layer Protective Film>

A first CNT lower layer protective film 115, such as a silicon nitride film, is deposited on the second sacrificial layer protective film 114, for example by CVD. A film thickness may be, for example, approximately 10 nm to 5 μm.

### <Process 13: (P13) in FIG. 14: Etching of Second Contact>

Using a mask, the first CNT lower layer protective film 115 and the second sacrificial layer protective film 114 are etched to expose a surface of the first wiring metal 108 at a bottom of the opening 113. Etching may be performed using either dry etching or wet etching.

### <Process 14: (P14) in FIG. 14: Deposition of Second Wiring Metal>

Deposit the conductive film of the second wiring metal 116 over the entire surface. The conductive film of the second wiring metal 116 may be, for example, a titanium alloy (e.g., TAV). A method for forming the second wiring metal 116 may include evaporation, sputtering, or printing, though not limited thereto. A film thickness of the second wiring metal 116 may be the same as that of the first wiring metal 108, and may be, for example, 10 nm to 10 μm, preferably 100 nm to 1 μm.

### <Process 15: (P15) in FIG. 14: Etching of Second Wiring Metal>

Using a photoresist mask, the conductive film of the second wiring metal 116 is selectively etched to form a wiring (electrode) pattern of the second wiring metal 116. The etching may be either dry etching or wet etching. In the next step, a first CNT film 117 is deposited between the opposing electrodes of the patterned second wiring metal (electrode) 116, forming channels in the CNTs between the electrodes. Although not particularly limited, the spacing (distance) S1 between the opposing electrodes of the patterned second wiring metal (electrode) 116 is preferably, for example, from 0.1 μm (micrometer) to 50 μm, and for miniaturization, for example, from 0.5 to 5 μm is more preferred.

### <Process 16: (P16) in FIG. 14: Forming First CNT Film>

Form the first CNT film 117. A CNT network formed by the first CNT film 117 (semiconductor-type CNT) is used as an element whose resistance value changes in response to temperature change. When forming a CNT film by spin-coating a CNT suspension onto an underlying surface (second wiring metal 116) achieving the CNT layer of a desired thickness requires multiple times of spin-coating the CNT suspension to be applied, making a fabrication process complicated. In a structure where multiple CNTs are aligned in the same direction, it is possible to impart anisotropy in physical properties, for example. However, using the spin-coating method, it is difficult to align multiple CNTs in the same direction (to impart anisotropy). Single-walled CNTs (SWNTs) are produced with a mixture of metallic CNTs and semiconductor CNTs. It is known that single-walled CNTs exhibit different electrical properties, metallic or semiconducting, depending on, for example, chirality.

Among technologies for efficient separation of semiconductor type CNTs with high purity, separation methods such as density gradient ultracentrifugation and gel column chromatography may pose issues in stability of device operation due to use of ionic surfactants. The first CNT film 117 may be formed by coating and drying dispersion containing CNTs, optionally subjected to heat treatment. The CNT dispersion liquid preferably contains a surfactant (non-ionic surfactant) in addition to CNTs.

Since the dispersion does not contain ionic surfactants, it is made possible to fabricate CNTs suitable for printing semiconductor-type technologies that do not affect device operation. Unlike ionic surfactants, non-ionic surfactants interact weakly with CNTs and may be easily removed after providing the dispersion onto the substrate, which enables to form stable CNT conductive paths, resulting in an excellent TCR value. Long-chain non-ionic surfactants are preferable because a network state is maintained when providing the dispersion onto the substrate. This is due to an increased distance between CNTs and reduced tendency for re-agglomeration after water evaporation. Non-ionic surfactants may be selected appropriately. It may be preferable to use one or a combination of non-ionic surfactants with a polyethylene glycol structure, typified by, for example, a polyoxyethylene alkyl ether-based surfactants, and non-ionic surfactants including a hydrophilic moiety that does not ionize and a hydrophobic moiety such as an alkyl chain, typified by, for example, alkyl glucoside-based non-ionic surfactants.

CₙH₂ₙ+1(OCH₂CH₂)ₘOH (1)

where n=preferably 12 to 18, m=10 to 100, preferably to 100.

In particular, polyoxyethylene (23) lauryl ether, polyoxyethylene (20) cetyl ether, polyoxyethylene (20) stearyl ether, polyoxyethylene (10) oleyl ether, polyoxyethylene (10) cetyl ether, polyoxyethylene (10) stearyl ether, polyoxyethylene (20) oleyl ether, polyoxyethylene (100) stearyl ether, etc., may be more preferred. Additionally, N,N-bis [3-(D-gluconamido)propyl]deoxycholamide, n-dodecyl β-D-maltoside, octyl β-D-glucopyranoside, and digitoxin may also be used. As non-ionic surfactants, polyoxyethylene sorbitan monostearate (molecular formula: C₆₄H₁₂₅O₂₆, trade name: Tween 60, manufactured by Sigma-Aldrich Co. LLC, etc.), polyoxyethylene sorbitan trioleate (molecular formula: C₂₄H₄₄O₆, trade name: Tween 85, Sigma-Aldrich Co. LLC, etc.), octylphenol ethoxylate (molecular formula: C₁₄H₂₂O(C₂H₄O)ₙ, n=1 to 10, trade name: Triton X-100, Sigma-Aldrich Co. LLC, etc.), polyoxyethylene (40) isooctylphenyl ether (molecular formula: C₈H₁₇C₆H₄₀ (CH₂CH₂₀)₄₀H, trade name: Triton X-405, Sigma-Aldrich, etc.), poloxamer (molecular formula: C₅H₁₀O₂, trade name: Pluronic, Sigma-Aldrich Co. LLC, etc.), polyvinylpyrrolidone (molecular formula: (C₆H₉NO)ₙ, n=5 to 100, Sigma-Aldrich, etc.), etc. may also be used.

Molecular length of a non-ionic surfactant may be preferably 5 to 100 nm, more preferably 10 to 100 nm, and most preferably 10 to 50 nm. When the molecular length is 5 nm or greater, especially 10 nm or greater, it is possible to keep an appropriate distance between CNTs after the dispersion is coated on an electrode(s) (including an area between electrodes), which is effective in suppressing agglomeration. Furthermore, the molecular length of 100 nm or less is preferable in constructing a CNT network structure.

Such non-ionic surfactants interact weakly with CNTs and can be easily removed after the CNT dispersion is coated, enabling formation of stable CNT conductive networks exhibiting an excellent TCR. Due to long molecular chains, the non-ionic surfactants increase a distance between CNTs when coated, making CNTs difficult to re-aggregate. Consequently, it is possible to form CNT networks including CNTs in an isolated distributed state, in which an appropriate spacing is kept, enabling significant resistance change against temperature change.

A method for obtaining the dispersed solution is not particularly limited, and known methods may be employed. For example, a solution containing CNTs can be prepared by mixing a CNT mixture, a dispersion medium, and a non-ionic surfactant. This solution is then subjected to ultrasonic treatment to disperse CNTs, thereby preparing a CNT dispersion solution (micelle dispersion solution).

Separation of semiconductor-type CNTs and metallic-type CNTs may be achieved, for example, using Electric-field-induced Layer Formation method. Regarding the ELF method, reference may be made to Reference Literature 4 (K. Ihara et al., “Separation of Metallic a n d Semiconducting Single-Wall Carbon Nanotube Solution by Vertical Electric Field”, J. Phys. Chem. C 2011, 115, 22827-22832), and Reference Literature 5 (JP5717233B). The following summarizes an example of a separation method using the ELF method. CNT (preferably single-walled CNT) is dispersed using a non-ionic surfactant. The CNT dispersion is poured into a cylindrical separation apparatus with electrodes placed respectively at a top and a bottom thereof. When a DC voltage is applied across the cylinder containing the CNT dispersion, the separation is performed by carrier-free electrophoresis. The separation mechanism may be estimated as follows: When CNTs are dispersed using a nonionic surfactant, semiconductor CNT micelles have a negative zeta potential, while metallic CNT micelles have a zeta potential with the opposite sign (positive) (recently, it has also been thought that metallic CNT micelles may have a slightly negative zeta potential or are almost uncharged). Therefore, when an electric field is applied to the CNT dispersion, due to a difference in zeta potential, semiconductor CNT micelles perform electrophoresis toward the anode (+) and metallic CNT micelles may perform electrophoresis toward the cathode (−). Ultimately, a layer concentrated with semiconductor CNTs is formed near the anode, and a layer concentrated with metallic CNTs is formed near the cathode in the separation apparatus. The separation voltage may be set appropriately by taking composition of the dispersion medium and a charge amount of the CNTs into account. The separation voltage (voltage between the anode and the cathode) may be preferably set to 1V or higher and 200V or lower, and more preferably to 10V or higher and 200V or lower. To reduce separation time, 100V or higher may be preferable. Furthermore, to suppress foam generation during the separation to maintain separation efficiency, 200V or lower may be preferable. Repeated separation improves purity. The dispersed solution after separation may be reset to an initial concentration and used for a next repetition of the separation operation. This enables further purification.

Through the aforementioned CNT dispersion, cutting, and separation processes, concentrated dispersion of semiconductor-type CNTs with a desired diameter and length may be obtained.

In this specification, CNT dispersion in which semiconductor-type CNTs are concentrated to a desired ratio may be referred to as “semiconductor-type CNT dispersion.” A separation tendency of metallic and semiconductor-type CNTs may be analyzed using micro-Raman spectroscopy and ultraviolet-visible-near-infrared (UV-Vis-NIR) spectrophotometry.

The zeta potential of the semiconductor-type CNT dispersion may be preferably between +5 mV and −40 m V, more preferably between +3 mV and −30 mV, and most preferably between +0 mV and −20 m V. That a value of the zeta potential of the semiconductor-type CNT dispersion is +5 m V or less indicates a low content of metallic-type CNTs, which is desirable. The value smaller than-40 mV makes separation difficult. Here, the zeta potential of the semiconductor-type CNT dispersion designates a zeta potential of the semiconductor-type CNT dispersion obtained, for example, through the separation process using the ELF method described above, which contains a non-ionic surfactant and semiconductor-type CNT micelles. In a non-limiting example, a value measured by an ELSZ system (Otsuka Electronics Co., Ltd.) is used as the zeta potential of the CNT dispersion.

The first CNT film 117 aligned in one direction may be formed by providing the semiconductor type CNT dispersion on the second wiring metal 116 such that the dispersion moves in the one direction on the second wiring metal 116. The first CNT film 117 horizontally aligned, may be formed on the second wiring metal 116 using, for example, CVD (vapor-phase catalytic CVD) in which a raw material gas containing film-forming carbon is reacted with a catalyst metal(s) at a high temperature.

As a non-limiting example, a thickness of the first CNT film 117 may be in a range of 0.5 nm to several μm, more preferably in the range of 0.7 nm to 500 nm. The CNTs may be either single-walled CNTs (minimum diameter: approximately 1 nm or less) or multi-walled CNTs (MWNTs) (minimum diameter: approximately 100 nm).

A thickness of the first CNT film 117 may be preferably 1 μm or less, and more preferably 500 nm or less, from a perspective of simplifying a manufacturing method. Such a thickness may be also preferable in that printing technologies can be applied effectively.

The thickness of the first CNT film 117 may be determined, for example, as an average thickness measured at any ten points on the first CNT film 117. Furthermore, a density of the first CNT film 117, as a non-limiting example, may be 0.3 g/cm³ to 1.4 g/cm³ preferably 0.8 g/cm³ to 1.3 g/cm³, and more preferably 1.1 g/cm³ to 1.2 g/cm³. The density of the first CNT film 117 may be calculated from a weight, area, and film thickness of the first CNT film 117. In the first CNT film 117, in addition to the above-mentioned components, materials such as negative thermal expansion materials (which contract upon heating), ion conductive agents (surfactants, ammonium salts, inorganic salts), resins, organic binders, etc., may be used as appropriate.

A CNT content in the first CNT film 117 may be selected appropriately. More specifically, 0.1 mass % or more based on a total mass of the first CNT film 117 may be effective, and more preferably, 1 mass % or more may be effective. For example, 30 mass % or even 50 mass % or more may be also preferable, and there may be such a case where 60 mass % or more may be preferable.

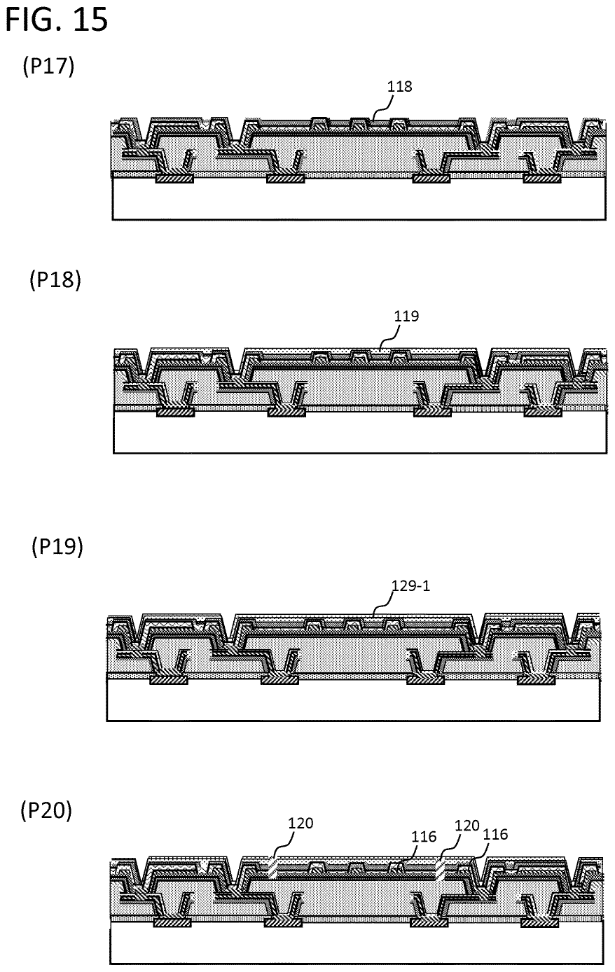

### <Process 17: (P17) in FIG. 15: Deposition of First CNT Upper Protective Layer A>

Deposit a first CNT upper protective film A 118 on the first CNT film 117. For example, a silicon nitride film or the like may be deposited using a CVD method. A film thickness may be, for example, approximately 10 nm to 5 μm.

### <Process 18: (P18) in FIG. 15: Deposition of First CNT Upper Protective Film B>

Deposit a first CNT upper protective film B 119 on the first CNT upper protective film A 118. For example, a silicon nitride film or the like may be deposited using a CVD method. A film thickness may be, for example, approximately 10 nm to 5 μm.

### <Process 19: (P19) in FIG. 15: Formation of First Absorption Film>

Deposit a first absorption film 129-1, corresponding to the first absorption layer 1 described above, on the first CNT upper protective film B 119. When using, for example, a SiC sintered body or a graphite sintered body belonging to the third absorber group (absorbing in both 20 the MWIR and LWIR bands) according to the combinations A and C in the above Table 1 as the first absorption film 129-1, deposition may be performed using, for example, a CVD method. When using, for example, a ceramic sintered body (oxide ceramic sintered body) belonging to the second absorber group (selectively absorbs in the LWIR band) according to the combination B in the above Table 1 as the first absorption film 129-1, it may be deposited using a sol-gel method of low-temperature synthesis, or a sputtering method. Alternatively, the film obtained may be pulverized, resulting powders dispersed in PMMA (polymethyl methacrylate), etc., and the resulting composite material spin-coated to form the film. For the first absorption film 129-1, based on the combination D in Table 1 above, the CNT film (with diameter or chirality controlled for absorption in the MWIR band) from the first absorber group (selectively absorbing in the MWIR band) may be prepared using a vacuum filtration (suction) method described in Reference Literature 3, etc. The film thickness of the first absorption film 129-1 be, m a y for example, approximately 10 nm to 5 μm.

### <Process 20: (P20) in FIG. 15: Formation of Slit>

Using a mask, slits (first slits) 120 are formed, by dry or wet etching, penetrating through the first absorption film 129-1, the first CNT upper protective film B 119, the first CNT upper protective film A 118, the second wiring metal 116, and the first CNT lower layer protective film 115 to reach a surface of the second sacrificial layer 112. Opposing elements (second wiring metal 116) are thermally isolated from each other via the slit (first slit) 120. The slits (first slits) 120 also provide paths for removal of residues of a sacrificial layer used in MEMS structure fabrication.

### <Process 21: (P21) in FIG. 16: Formation of Third Sacrificial Layer>

Form a third sacrificial layer 121 on the first absorption film 129-1. The third sacrificial layer 121 may be formed by spin coating a polyimide resin (e.g., photosensitive polyimide). A height of the third sacrificial layer 121 defines a distance (d3 in FIG. 10A) between the second layer 12 and the third layer 13. The third sacrificial layer 121 is exposed and developed to form openings 122 over the contact area (136 in FIG. 8) on the second wiring metal 116. A shape of the opening 122 may be tapered rather than vertical. The thickness of the third sacrificial layer 121 may be, for example, approximately nm to 5 μm.

### <Process 22: (P22) in FIG. 16: Formation of Third Sacrificial Layer Protective Film>

A protective film (third sacrificial layer protective film) 123 is formed to cover the third sacrificial layer 121. For the third sacrificial layer protective film 123, for example, a silicon nitride film or the like may deposited using a CVD method. A thickness of the film 123 may be, for example, approximately 10 nm to 5 μm.

### <Process 23: (P23) in FIG. 16: Formation of the Second CNT Sublayer Protective Film>

On the third sacrificial layer protective film 123, a protective film (second CNT lower protective film) 124 for the sublayer of the second CNT film is formed, for example, by depositing a silicon nitride film using a CVD method. A thickness of the film 124 may be, for example, approximately 10 nm to 5 μm.

### <Process 24: (P24) in FIG. 16: Etching of Second Contact>

In the opening 122, the second CNT lower protective film 124, the third sacrificial layer protective film 123, the first CNT upper protective film B 119, and the first CNT upper protective film A 118 are etched away to expose a surface of the second wiring metal 116 in the opening 122. Wet or dry etching may be used.

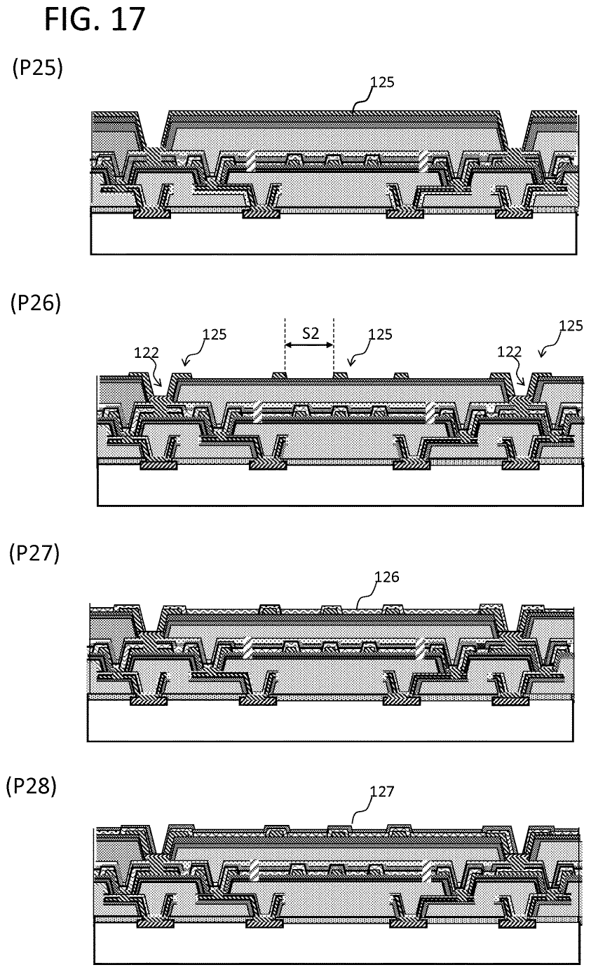

### <Process 25: (P25) in FIG. 17: Deposition of Third Interconnect Metal>

Deposit a conductive film for the third wiring metal 125.

The conductive film may be titanium aluminum vanadium (TAV). A method for forming the third wiring metal 125 may include evaporation, sputtering, and printing methods, though not limited thereto. A thickness of the conductive film for the third wiring metal 125 may be nm to 10 μm, preferably 100 nm to 1 μm. The film thickness may be the same as that of the first wiring metal 108.

### <Process 26: (P26) in FIG. 17: Etching of Third Wiring Metal >

Using a mask, the conductive film of the third wiring metal 125 is etched to form a wiring (electrode) pattern of the third wiring metal 125. The etching may be either wet or dry etching. A spacing (distance) S2 between opposing electrodes of the patterned third wiring metal 125 may preferably be, for example, from 0.1 μm to 50 μm, and for miniaturization, for example, from 0.5 to 5 μm is more preferred.

### <Process 27: (P27) in FIG. 17: Deposition of Second CNT Film>

Deposit a second CNT film 126 on the second CNT lower protective film 124 and the third wiring metal 125. The second CNT film 126 may be deposited using the same method as the previously described first CNT film 117 and may have the same film thickness and the same characteristics.

### <Process 28: (P28) in FIG. 17: Deposition of Second CNT Upper Protective Film A>

Deposit a second CNT upper protective film A 127, such as a silicon nitride film, onto the second CNT film 126, for example, using a CVD method. A thickness of the film 127 may be, for example, approximately 10 nm to 5 μm.

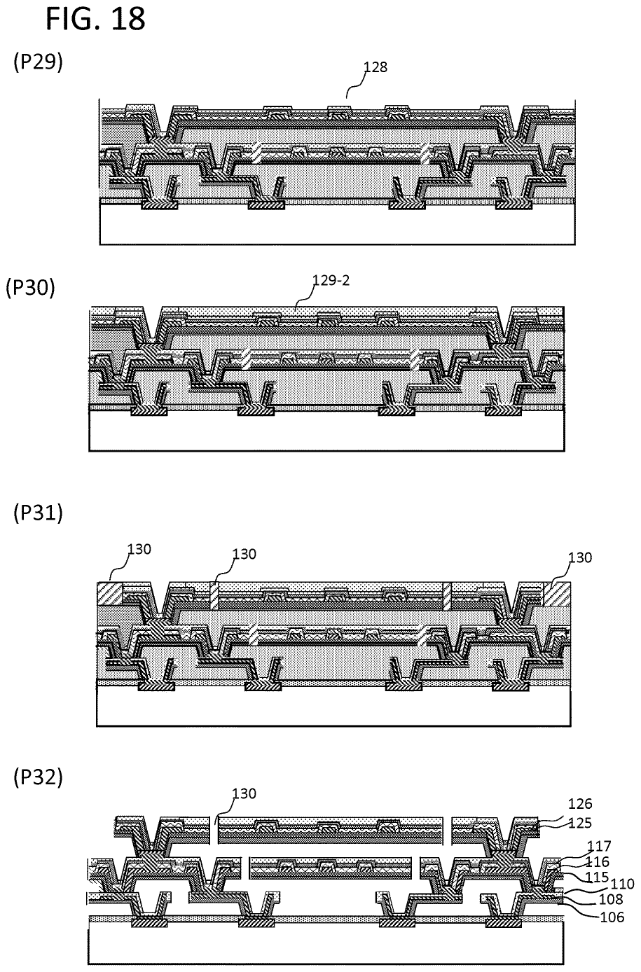

### <Process 29: (P29) in FIG. 18: Deposition of Second CNT Upper Protective Film B>

Deposit a second CNT upper protective film B 128, such as a silicon nitride film, on the second CNT upper protective film A 127, for example, using a CVD method. A thickness of the film 128 may be, for example, approximately 10 nm to 5 μm.

### <Process 30: (P30) in FIG. 18: Formation of Second Absorption Film>

Form a second absorption film 129-2 corresponding to the second absorption layer 2 described above on the second CNT upper protective film B 128. When the second absorption film 129-2 is used as the mid-infrared absorption film, it corresponds to the combination A or B in Table 1 for the first absorption layer 1 and the second absorption layer 2. When using a CNT film (with diameter or chirality controlled for absorption in the MWIR band) from the first absorber group (selectively absorbing in the MWIR band) as the second absorption film 129-2, the vacuum filtration (suction) method described in, for example, Reference Literature 3 may be used. Alternatively, when using a ceramic sintered body (oxide ceramic sintered body) from the second absorber group (absorbing in the LWIR band) as the second absorption film 129-2 according to combinations C or D in Table 1 above, it may be fabricated using a sol-gel method of low-temperature synthesis or a sputtering method. The film obtained by these methods may be pulverized, the resulting powders dispersed in PMMA, etc., and the resulting composite material spin-coated to form a film. A thickness of the second absorption film 129-2 may be, for example, approximately 10 nm to 5 μm.

### <Process 31: (P31) in FIG. 18: Formation of Second Slit>

Form slits (second 130 slits) each having a predetermined shape penetrating through the second absorption film 129-2, the second CNT upper protective film B 128, the second CNT upper protective film A 127, the second CNT film 126, the third wiring metal 125, the second CNT lower protective film 124, and the third sacrificial layer protective film 123. The formation of the slits (second slits) 130 may be performed using dry etching. Alternatively, the slits (second slits) 130 may be drilled using laser processing.

### <Process 32: (P32) in FIG. 18: Etching of Sacrificial Layer>

Selectively remove the first sacrificial layer 104, the second sacrificial layer 112, and the third sacrificial layer 121. When these sacrificial layers are polyimide, they may be removed by ashing or etching through immersion in a polyimide etching solution. In this case, the first slits 120 and the second slits 130 serve as pathways for sacrificial layer removal.

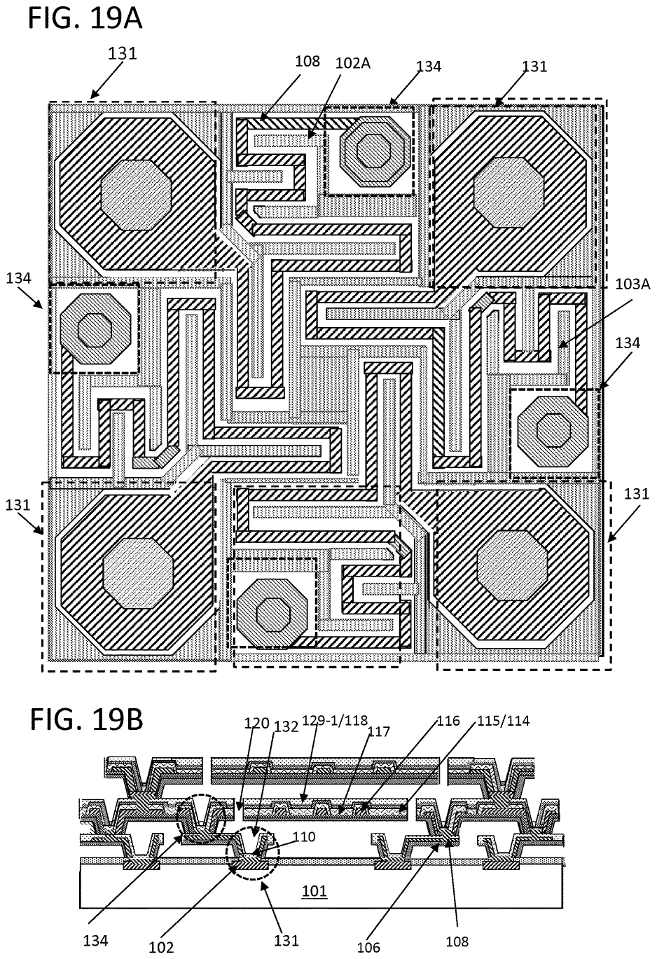

FIG. 19A is a schematic diagram of a wiring pattern of the first layer 11 in FIG. 8, viewed from above. FIG. 19B is a schematic cross-sectional diagram of the cell ((P32) in FIG. 18) in the fabrication process described with reference to FIGS. 11 to 18, illustrating reference symbols corresponding to the elements in FIG. 19A. (Note that FIG. 19B is a cross-sectional diagram for schematically illustrating the fabrication process and does not perfectly correspond to the wiring pattern in FIG. 19A). As described with reference to FIG. 10A, the concave-shaped (cup-shaped or bowl-shaped) connection part 131 has its surface side as the open end 132. At its bottom, the protective film (106 in FIG. 19B) is etched away, and the first wiring metal 108 comes in contact with the contact electrode (102 in FIG. 19B) on the substrate (101 in FIG. 19B), and the surface of the first wiring metal 108 is covered by the protective film (110 in FIG. 19B). The first wiring metal 108 has a meander-like wiring pattern, though not limited thereto. Between opposing wirings of the first wiring metal 108, provided the wiring pattern 102A which is patterned from the same conductive film as the contact electrode 102) covered by the protective film 103 provided on a surface of the substrate 101.

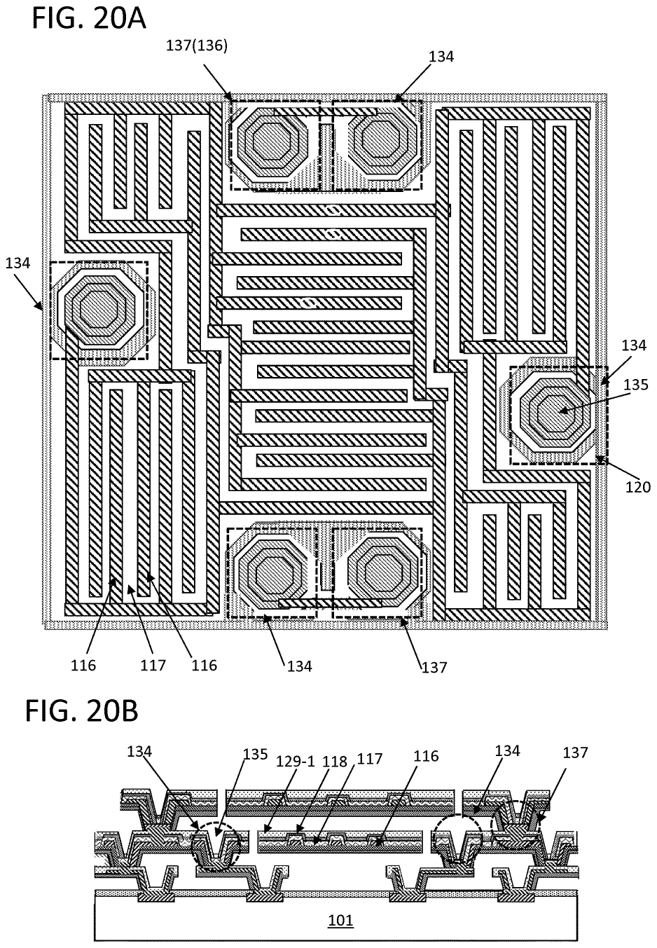

FIG. 20A is a schematic diagram of a wiring pattern of the second layer 12 in FIG. 8 as viewed from above. FIG. 20B is a schematic cross-sectional view of the cell ((P32) in FIG. 18) in the fabrication process described with reference to FIGS. 11 to 18, illustrating reference symbols corresponding to the elements in FIG. 20A. (Note that FIG. 20B is a cross-sectional diagram schematically illustrating the fabrication process and not perfectly corresponding to the wiring pattern in FIG. 20A). The concave-shaped (cup-shaped or bowl-shaped) of the connection part 134 has its surface side as the open end 135. At its bottom, the protective film (115/114 in FIG. 19B) is etched away, and the second wiring metal 116 contacts with a contact area 133 of the first wiring metal 108. The surface of the second wiring metal 116 is covered by the first CNT film (117 in FIG. 19B), the protective film (118 in FIG. 19B), and the first absorption film 129-1. The second wiring metal 116 has an interdigital wiring pattern wherein teeth extend alternately from one side (base) to other side in a nested configuration between two parallel electrodes each forming a base of the teeth. The first CNT film 117 is formed over an entire surface, but the first CNT film 117 formed between adjacent wirings (electrodes) 116 forms the effective CNT network. The slit (first slit) 120 thermally separates opposing elements.

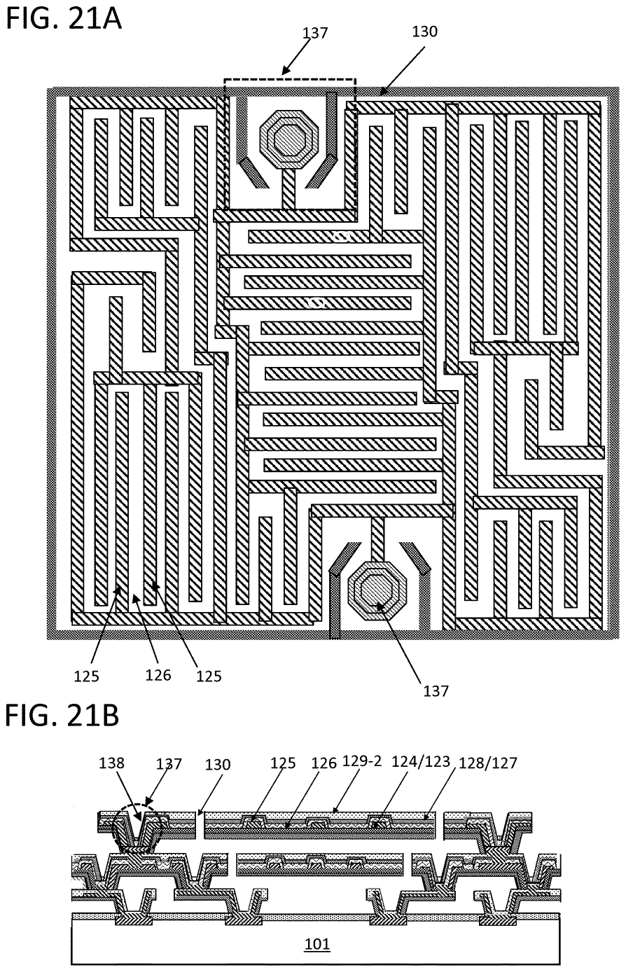

FIG. 21A is a schematic diagram viewed from above of the wiring pattern of the third layer 13 of the cell 10 in FIG. 8. FIG. 21B is a schematic cross-sectional diagram of the cell (the cross-section of (P32) in FIG. 18), with reference symbols corresponding to the elements in FIG. 21A. Note that FIG. 21B is a cross-sectional diagram schematically illustrating the fabrication process and not perfectly corresponding to the wiring pattern in FIG. 21A. The concave-shaped (cup-shaped or bowl-shaped) of the connection part 137 has its surface side as the open end 138. At its bottom, the protective film (124/123 in FIG. 21B) is etched away, and the third wiring metal 125 contacts with a contact area 136 of the second wiring metal 116. The surface of the third wiring metal 125 is covered by the second CNT film (126 in FIG. 21B), the protective film (128/127 in FIG. 21B), and the second absorption layer 129-2. The third wiring metal 125 has an interdigital wiring pattern wherein the teeth extend alternately from one side (base) to the other in a nested configuration between two parallel electrodes forming the base of the teeth. The second CNT film 126 is formed over the entire surface, with the second CNT film 126 formed between adjacent wiring (electrodes) forming an effective CNT network. The slit (second slit) 130 thermally separates the opposing elements and serves as a disposal pathway for residues during sacrificial layer removal.

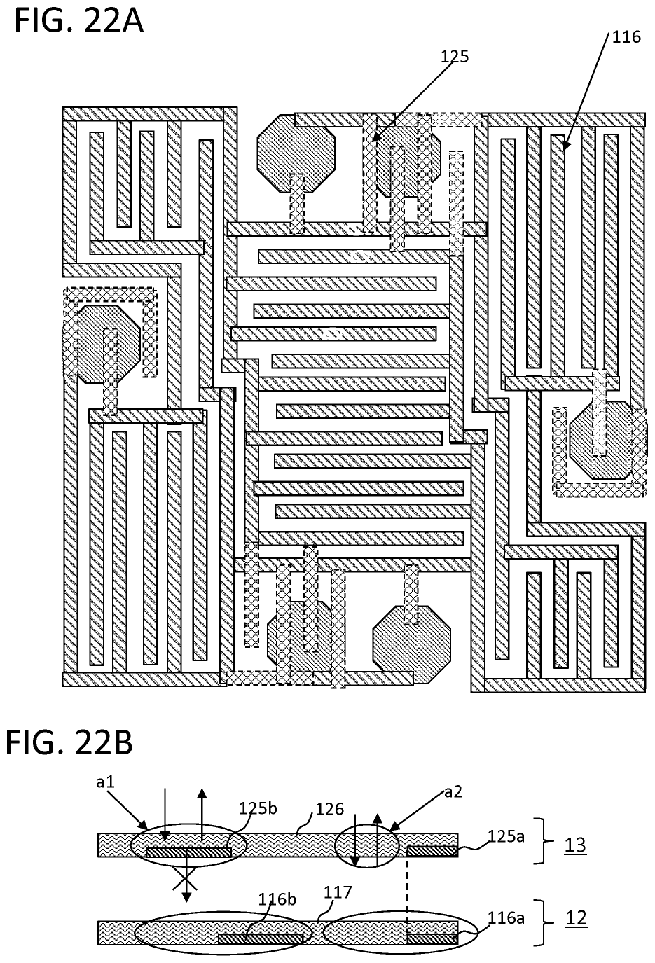

FIG. 22A is a diagram illustrating the second wiring metal 116 of the second layer 12 and the third wiring metal 125 of the third layer 13 of the cell 10 in FIG. 8 with wiring patterns (electrode patterns) superimposed. Except for a part of the third wiring metal 125 (the wiring pattern shown in a meshed area), two-dimensional patterns of the second wiring metal 116 and the third wiring metal 125 overlap over 90% of the entire pattern area.

As schematically shown in FIG. 22B, light is reflected at the electrode 125b of the third wiring metal 125 in the third layer 13 and does not reach a light-receiving area of the second layer 12. A light absorbance is greater in area a2 without the electrode than in area a1 with the electrode 125b. Therefore, in the second wiring metal of the second layer 12, the electrode 116a is placed not at a position of the electrode 116b without an electrode in the third layer 13 above, but at a position directly below the electrode 125a of the third layer 13 where light does not reach. As indicated by the x marks in FIG. 22B, placing an area with high light absorption in the second layer 12 where light does not enter is ineffective. Therefore, as shown in FIG. 22A, an overlapping portion between the two-dimensional patterns of the second wiring metal 116 in the second layer 12 and the third wiring metal 125 in the third layer 13 may be made as large as possible.

In the present disclosure, materials other than CNT may be adopted as the bolometer film. As example embodiments, a two-layer structure including a first absorption layer 1 and a second absorption layer 2 with different infrared absorption characteristics is described, but the number of absorption layers is, as a matter of course, not limited to two.

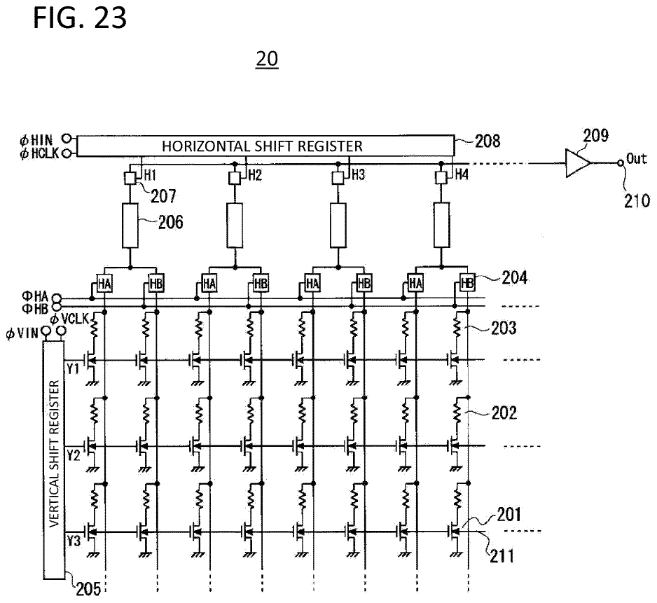

An example of an infrared sensor equipped with a cell array formed by arranging the cell 10 in a two-dimensional array is described below. FIG. 23 schematically illustrates an example of a bolometer-type infrared imaging apparatus 20 (Reference Literature 6 (JP4854410B)). As one example, a resistor element 202 in FIG. 23 (a thermoelectric conversion element in Reference Literature 6) may also be the cell 10 equipped with the first absorption layer 1 and second absorption layer 2 shown in FIG. 1. Referring to FIG. 23, the bolometer-type infrared imaging apparatus 20 includes the resistor element 202, whose resistance changes with temperature, arranged in a two-dimensional matrix. The bolometer-type infrared imaging apparatus 20 detects and outputs an infrared signal received at each element. In FIG. 23, the signal can be processed in parallel by a selected pixel switch 201 selected by an output signal of a vertical shift register 205, and a readout circuit 206 connected to the resistor element 202 via a horizontal switch 204. The output from the readout circuit 206 is sequentially output to outside via the output terminal 210 by a horizontal shift register 208. The resistor element 202 is formed in a two-dimensional matrix on the substrate and are sequentially selected by switching via the pixel switch 201 and horizontal switch 204. The pixel switch 201 is provided at the intersection of a signal line 203 and a scan line 211. The pixel switch 201 may be configured as an N-channel MOSFET (Metal Oxide Semiconductor Field Effect Transistor) with the source grounded, the drain connected to the signal line 203 via the resistor element 202, and the gate connected to the scan line. Alternatively, the source may be connected to a power supply, the drain connected to the signal line 203 via the resistor element 202, and the gate formed by a P-channel MOSFET connected to the scan line. The signal line 203 is connected to the readout circuit 206 via the horizontal switch 204. The output of the readout circuit 206 is connected to an output buffer 209 via a multiplexer switch 207. The on/off control of the multiplexer switch 207 is performed by an output signal of the horizontal shift register 208. In the example of FIG. 23, the readout circuits 206 are provided for every two columns of the matrix to read out the signals from each resistor element 202. The vertical shift register 205 sequentially selects each row of the matrix, while the horizontal shift register 208 sequentially selects the multiplexer switches 207, outputting the output from each readout circuit 206 to the output buffer 209. Although not particularly limited, as another example of an embodiment, the first absorption layer 1 and second absorption layer 2 of the cell 10 in FIG. 1 are each provided as the resistor element 202 shown in FIG. 23 including the two-stage array corresponding to the first absorption layer 1 and second absorption layer 2, and corresponding to the two-stage array, including two sets of circuitry including the readout circuit 206, the multiplexer switch 207, the output buffer 209, and the output terminal 210 on the ROIC substrate. The vertical shift register 205 and horizontal shift register 208 are shared for the two-stage array. The two-stage array and two sets of circuitry may be operated at the same timing (same clock). By combining the signals from the two sets of output terminals 210, an image (composite image) is acquired. This enables simultaneous image acquisition at the same timing in composite imaging that combines images from different wavelength bands.

The above embodiments/examples may be listed as the following supplementary notes (Notes), though not limited thereto.
(Note 1) A bolometer-type infrared detector includes a plurality of absorption layers stacked spaced apart from each other, two or more thereof having different absorption wavelength spectra, configured to acquire a plurality of images in different wavelength bands with a same field of view.
(Note 2) In the bolometer-type infrared detector according to Note 1, a wiring layer is provided directly below and separately from each of the plurality of absorption layers.
(Note 3) In the bolometer-type infrared detector according to Note 1 or 2, the plurality of absorption layers include materials with light absorption characteristics thereof different to each other.
(Note 4) In the bolometer-type infrared detectors according to any one of Notes 1 to 3, provided a plurality of semiconductor-type carbon nanotube films, each arranged beneath each of the plurality of absorption layers.
(Note 5) In the bolometer-type infrared detector according to Note 4, provided an electrode covered with the semiconductor-type carbon nanotube film, the electrode including:
   a comb-shaped electrode having a plurality of electrodes extending parallel to each other in a direction perpendicular to a longitudinal direction of a base member; and/or
   a cross-finger electrode including a first comb-shaped electrode and a second comb-shaped electrode arranged opposed, each of the first comb-shaped electrode and the second comb-shaped electrode having a plurality of electrodes extending parallel to each other in a direction perpendicular to a longitudinal direction of a base member, the plurality of electrodes of the first comb-shaped electrode and the second comb-shaped electrode opposed and nested each other without touching
(Note 6) The bolometer-type infrared detectors according to any one of Notes 1 to 4 includes: a first wiring layer with a first side thereof facing the substrate covered with a protective film, and a second side opposite to the first side and an outer edge thereof both covered with a protective film;
   a second wiring layer with a first side thereof facing the first wiring layer covered with a protective film, on a second side opposite to the first side of the second wiring layer, at least a semiconductor-type first carbon nanotube film, a protective film covering the semiconductor-type first carbon nanotube film, and a first absorption layer with a first absorption wavelength spectrum laminated;
   a third wiring layer with a first side thereof facing the second wiring layer covered with a protective film, on a second side opposite to the first side of the third wiring layer, at least a semiconductor-type second carbon nanotube film, a protective film covering the semiconductor-type second carbon nanotube film, and a second absorption layer with a second absorption wavelength laminated.

The first wiring layer includes a first connection part with one end in contact with a contact electrode on the substrate, the second wiring layer includes a second connection part with one end in contact with a first contact area of the first wiring layer, and the third wiring layer includes a third connection part with one end in contact with a second contact area of the second wiring layer. The first connection part serves as support member to support the first wiring layer at a predetermined distance from the substrate, the second connection part serves as a support member to support the second wiring layer at a predetermined distance from the first wiring layer, and the third connection part serves as a support member to support the third wiring layer at a predetermined distance from the second wiring layer.
(Note 7) In the bolometer-type infrared detector according to Note 6, one end of the second connection part is configured to contact with the first wiring layer at the first contact area at a position different from the first connection part of the first wiring layer, and one end of the third connection part is configured to contact with the second wiring layer at the second contact area at a position different from the second connection part of the second wiring layer.
(Note 8) In the bolometer-type infrared detector according to Note 6 or 7, the second absorption layer includes an absorber belonging to either a first absorber group including one or more absorbers that selectively absorb radiation of a mid-infrared wavelength band, or a second absorber group including one or more absorbers that selectively absorb radiation of a long-infrared wavelength band, while the first absorption layer includes an absorber belonging to either an absorber group different from that selected for the second absorption layer out of the first absorber group and the second absorber group, or a third absorber group including an absorber that absorbs radiation of both the mid-infrared wavelength band and the long-infrared wavelength band.
(Note 9) In the bolometer-type infrared detectors according to any one of Notes 6 to 8, the first connection part includes a sidewall configured with, from an outer side thereof, the protective film facing the substrate, the first wiring layer, and the protective film on the second side of the first wiring layer. One end of the first connection part includes a laminated structure of the first wiring layer with the first side thereof in contact with the contact electrode, and the protective film on the second side of the first wiring layer, the first connection part having an end opposite to the one end open-ended.

The second connection part includes a sidewall configured with, from an outer side, the protective film on a first side facing the first wiring layer of the second wiring layer, the second wiring layer, the semiconductor-type first carbon nanotube film, the protective film covering the semiconductor-type first carbon nanotube film and the first absorption layer. One end of the second connection part includes a laminated structure of the second wiring layer with a first side in contact with the first contact area of the first wiring layer, the semiconductor-type first carbon nanotube film, the protective film covering the first semiconductor-type carbon nanotube film, and the first absorption layer, the second connection part having an end opposite to the one end open-ended.

The third connection part includes a sidewall configured with, from an outer side, the protective film on the first side of the third wiring layer, the third wiring layer, the semiconductor-type second carbon nanotube film, the protective film covering the semiconductor-type second carbon nanotube film, and the second absorption layer. One end of the third connection part includes a laminated structure of the third wiring layer with the first side in contact with the second contact area second of the wiring layer, the semiconductor-type second carbon nanotube film, the protective film covering the semiconductor-type second carbon nanotube film, and the second absorption layer, the third connection part having an end opposite to the one end open-ended.
(Note 10) An array sensor includes a plurality of cells arranged as a two-dimensional array, each including the bolometer-type infrared detector according to any one of Notes 1 to 9.
(Note 11) A method for manufacturing a bolometer-type infrared detector includes:
(a) forming a first sacrificial layer on a protective film having an opening over a contact electrode on a substrate, and patterning the first sacrificial layer to form a first opening reaching the contact electrode;
(b) depositing a first protective film on the first sacrificial layer, and patterning the first protective film to form a second opening reaching the contact electrode;
(c) depositing a first conductive film on the first protective film, and patterning the first conductive film to form a first wiring layer;
(d) depositing a second protective film on the first wiring layer, and patterning the second protective film to form a third opening that exposes a portion of a surface of the first wiring layer at a first connection position with a second wiring layer;
(e) forming a second sacrificial film on the second protective film, patterning the second sacrificial film to form a fourth opening having a smaller diameter than the third opening at the first connection position with the second wiring layer;
(f) depositing a third protective film on the second sacrificial layer, and patterning the third protective film to form a fifth opening having a smaller diameter than the fourth opening at the first connection position with the first wiring layer;
(g) depositing a second conductive film on the third protective film, and patterning the second conductive film to form the second wiring layer;
(h) laminating a semiconductor-type first carbon nanotube film, a fourth protective film covering the semiconductor-type first carbon nanotube film, and a first absorption film having a first absorption wavelength spectrum, on the second wiring layer;
(i) forming a third sacrificial layer on the first absorption layer, patterning the third sacrificial layer to form a sixth opening wherein a portion of a surface of the second conductive film is exposed at a second connection position with a third wiring layer;
(j) Depositing a fifth protective film to cover the third sacrificial layer, and patterning the fifth protective film to form a seventh opening having a smaller diameter than the sixth opening at the second connection position with the second wiring layer;
(k) depositing a third conductive film on the fifth protective film and patterning the third conductive film to form the third wiring layer;
(l) laminating a semiconductor-type second carbon nanotube film, a sixth protective film covering the semiconductor-type second carbon nanotube film, and a second absorption film having a second absorption wavelength spectrum, on the third wiring layer; wherein
(m) by selectively removing the first sacrificial layer, the second sacrificial layer, and the third sacrificial layer,
a first connection part with one end in contact with the contact electrode on the substrate to ensure electrical connection between the contact electrode and the first wiring layer, while supporting the first wiring layer from the first wiring layer a t a below to maintain predetermined distance from the substrate;
a second connection part with one end in contact with the first connection position of the first wiring layer to ensure electrical connection between the first wiring layer and the second wiring layer, while supporting the second wiring layer from below to maintain the second wiring layer at a predetermined distance from the first wiring layer, and
a third connection part with one end in contact with the second connection position of the second wiring layer to ensure electrical connection between the second wiring layer and the third wiring layer, while supporting the third wiring layer from below to maintain the third wiring layer at a predetermined distance from the second wiring metal.

The disclosures of each of the above-mentioned documents are hereby incorporated by reference into this document. Within the scope of the disclosure of the present application (including the claims), modifications, adjustments, and combinations of embodiments or examples based on the fundamental technical concept are possible. Furthermore, within the scope of the claims of the present disclosure, various combinations, or selections of the disclosed elements (including each element of the appended claims, each element of the embodiments, each element of the drawings, etc.) are possible. That is, the present disclosure naturally encompasses the entire disclosure, including the claims, and various modifications and alterations that would be obvious to one skilled in the art based on the technical concept.

What is claimed is:

1. A bolometer-type infrared detector including:
a plurality of absorption layers stacked spaced apart from each other, two or more thereof having absorption wavelength spectra different to each other, wherein the plurality of absorption layers are configured to acquire a plurality of images in different wavelength bands with a same field of view.

2. The bolometer-type infrared detector according to claim 1, including
a plurality of wiring layers, each provided beneath each of the plurality of absorption layers.

3. The bolometer-type infrared detector according to claim 1, wherein the plurality of absorption layers include
materials with light absorption characteristics thereof different to each other.

4. The bolometer-type infrared detector according to claim 1, including:
a plurality of semiconductor-type carbon nanotube films, each arranged beneath each of the plurality of absorption layers.

5. The bolometer-type infrared detector according to claim 4, including an electrode including:
a comb-shaped electrode having a plurality of electrodes extending parallel to each other in a direction perpendicular to a longitudinal direction of a base member; and/or
a cross-finger electrode including a first comb-shaped electrode and a second comb-shaped electrode arranged opposed, each of the first comb-shaped electrode and the second comb-shaped electrode including a plurality of electrodes extending parallel to each other in a direction perpendicular to a longitudinal direction of a base member, the plurality of electrodes of the first comb-shaped electrode and the second comb-shaped electrode alternately arranged in a nested manner.

6. The bolometer-type infrared detector according to claim 4, including
a plurality wiring layers corresponding of respectively to the plurality of semiconductor-type carbon nanotube films, wherein on each of the plurality of wiring layers is provided a laminated structure including:
each of the plurality of semiconductor-type carbon nanotube films;
a protective film covering the each of the plurality of semiconductor-type carbon nanotube films; and
each of the plurality of absorption layers.

7. The bolometer-type infrared detector according to claim 2, wherein the plurality of wiring layers includes:
a first wiring layer with a first side thereof facing a substrate covered with a protective film, and a second side opposite to the first side and an outer edge thereof both covered with a protective film;
a second wiring layer with a first side thereof facing the first wiring layer covered with a protective film, wherein on a second side opposite to the first side of the second wiring layer, a laminated structure including at least a semiconductor-type first carbon nanotube film, a protective film covering the semiconductor-type first carbon nanotube film, and a first absorption layer with a first absorption wavelength spectrum is arranged; and
a third wiring layer with a first side thereof facing the second wiring layer covered with a protective film, wherein on a second side opposite to the first side of the third wiring layer, a laminated structure including at least a semiconductor-type second carbon nanotube film, a protective film covering the semiconductor-type second carbon nanotube film, and a second absorption layer with a second absorption wavelength is arranged.

8. The bolometer-type infrared detector according to claim 7, wherein the first wiring layer includes a first connection part with one end in contact with a contact electrode on a substrate;
the second wiring layer includes a second connection part with one end in contact with a first contact area of the first wiring layer, and the third wiring layer includes a third connection part with one end in contact with a second contact area of the second wiring layer, wherein the first connection part serves as a support member to support the first wiring layer at a predetermined distance from the substrate,
the second connection part serves as a support member to support the second wiring layer at a predetermined distance from the first wiring layer, and
the third connection part serves as a support member to support the third wiring layer at a predetermined distance from the second wiring layer.

9. The bolometer-type infrared detector according to claim 7, wherein the second wiring layer and the third wiring layer are configured to have respective wiring patterns overlapping at a predetermined ratio or more with regards to a pattern area.

10. A bolometer-type infrared detector including:
a substrate;
a first wiring layer with a first side thereof facing the substrate covered with a protective film, and a second side opposite to the first side and an outer edge thereof both covered with a protective film;
a second wiring layer with a first side thereof facing the first wiring layer covered with a protective film, wherein on a second side opposite to the first side of the second wiring layer, a laminated structure including at least a semiconductor-type first carbon nanotube film, a protective film covering the semiconductor-type first carbon nanotube film, and a first absorption layer with a first absorption wavelength spectrum is arranged; and
a third wiring layer with a first side thereof facing the second wiring layer covered with a protective film, wherein on a second side opposite to the first side of the third wiring layer, a laminated structure including at least a semiconductor-type second carbon nanotube film, a protective film covering the semiconductor-type second carbon nanotube film, and a second absorption layer with a second absorption wavelength is arranged,
wherein the first wiring layer includes a first connection part with one end in contact with a contact electrode arranged on the substrate,
the second wiring layer includes a second connection part with one end in contact with a first contact area of the first wiring layer, and the third wiring layer includes a third connection part with one end in contact with a second contact area of the second wiring layer, wherein the first connection part serves as a support member to support the first wiring layer at a predetermined distance from the substrate,
the second connection part serves as a support member to support the second wiring layer at a predetermined distance from the first wiring layer, and
the third connection part serves as a support member to support the third wiring layer at a predetermined distance from the second wiring layer.

11. The bolometer-type infrared detector according to claim 10, wherein one end of the second connection part is made to be in contact with the first wiring layer at the first contact area at a position different from the first connection part of the first wiring layer, and one end of the third connection part is made to be in contact with the second wiring layer at the second contact area at a position different from the second connection part of the second wiring layer.

12. The bolometer-type infrared detector according to claim 10, wherein the second absorption layer includes, an absorber selected from one of the following groups:
a first absorber group containing an absorber that selectively absorbs in the mid-infrared wavelength band, or
a second absorber group containing an absorber that selectively absorbs in the long-infrared wavelength band; and
the first absorption layer includes an absorber selected from one of the following groups:
the group different from the absorber group selected for the second absorption layer among the first absorber group or the second absorber group, or
a third absorber group containing an absorber that absorbs in both the mid-infrared wavelength band and the long-infrared wavelength band.

13. The bolometer-type infrared detector according to claim 10, wherein the first connection part includes:
a sidewall including, from an outer side thereof, the protective film on the first side of the first wiring layer, the first wiring layer, and the protective film on the second side of the first wiring layer;
one end including a laminated structure including the first wiring layer in contact with the contact electrode, and the protective film on the second side of the first wiring layer; and
an other end opposite to the one end configured to be open ended;
wherein the second connection part includes:
a sidewall including, from an outer side thereof, the protective film on the first side of the second wiring layer, the second wiring layer, the semiconductor-type first carbon nanotube film, and the protective film covering the semiconductor-type first carbon nanotube film and the first absorption layer;
one end including a laminated structure including the second wiring layer in contact with the first contact area of the first wiring layer, the semiconductor-type first carbon nanotube film, the protective film covering the first semiconductor-type carbon nanotube film, and the first absorption layer; and
an other end opposite to the one end configured to be open ended, and wherein the third connection part includes:
a sidewall including, from an outer side thereof, the protective film on the first side of the third wiring layer, the third wiring layer, the semiconductor-type second carbon nanotube film, the protective film covering the semiconductor-type second carbon nanotube film, and the second absorption layer; and
one end including a laminated structure including the third wiring layer in contact with the second contact area of the second wiring layer, the semiconductor-type second carbon nanotube film, the protective film covering the semiconductor-type second carbon nanotube film, and
an other end opposite to the one end configured to be open ended.

14. An array sensor including a plurality of cells arranged as a two-dimensional array, each of plurality of cells including the bolometer-type infrared detector as set forth in claim 1.
